(19) United States
(12) Patent Application Publication
(10) Pub. No.: US 2018/0062887 A1
(43) Pub. Date: Mar. 1, 2018

(54) USING FULL TERNARY TRANSCODING IN I3C HIGH DATA RATE MODE

(71) Applicant: QUALCOMM Incorporated, San Diego, CA (US)

(72) Inventor: Shoichiro SENGOKU, Dublin, CA (US)

(21) Appl. No.: 15/659,408

(22) Filed: Jul. 25, 2017

Related U.S. Application Data
(60) Provisional application No. 62/379,233, filed on Aug. 24, 2016.

(51) Int. Cl. H04L 25/49; H04L 7/00

(52) U.S. Cl. CPC H04L 25/4923; H04L 7/0037; H04L 25/4906; H04L 7/0087

(57) ABSTRACT

Apparatus, systems and methods for improving coexistence on a multi-wire interface are disclosed. A method of transmitting data on a multi-wire interface includes providing a plurality of data bits in a word to be transmitted on the multi-wire interface, transcoding the word to be transmitted to obtain a first multi-digit ternary number representative of the numerical value of the word to be transmitted, inserting marker digits into the first multi-digit ternary number to obtain a second multi-digit ternary number, and generating a sequence of symbols. Each symbol in the sequence of symbols may be generated using a digit of the second multi-digit ternary number and a preceding symbol in the sequence of symbols. The preconfigured values and the preconfigured locations of the marker digits may be selected to prevent occurrence of I3C HDR Exit or HDR I3C Restart signaling when the sequence of symbols is transmitted on the multi-wire interface.

### CROSS-REFERENCE TO RELATED APPLICATIONS

This application claims priority to and the benefit of Provisional Patent Application No. 62/379,233 filed in the U.S. Patent Office on Aug. 24, 2016, the entire content of which applications are incorporated herein by reference below in their entirety and for all applicable purposes.

### TECHNICAL FIELD

The present disclosure pertains to enabling efficient operations over data communication interfaces and, more particularly, facilitating error detection in data communication interfaces that employ symbol transition clocking transcoding.

### BACKGROUND

Data communication interfaces may employ symbol transition clocking transcoding to embed clock information in sequences of symbols that encode data to be transmitted over an interface that has multiple signal wires, thereby obviating the need for dedicated clock signal wires.

In certain examples of multi-signal data transfer, multi-wire differential signaling such as N-factorial (N!) low-voltage differential signaling (LVDS), transcoding (e.g., the digital-to-digital data conversion of one encoding type to another) may be performed to embed symbol clock information by causing symbol transition at every symbol cycle, instead of sending clock information in separate data lanes (differential transmission paths). Embedding clock information by such transcoding can also minimize skew between clock and data signals, as well as to eliminate the need for a phase-locked loop (PLL) to recover the clock information from the data signals. In one example, a two-wire serial bus operated in accordance with conventional Inter-Integrated Circuit (I2C) protocols can be adapted to support I3C protocols defined by the Mobile Industry Processor Interface (MIPI) Alliance, including I3C High Data Rate (HDR) modes which use symbol transition clocking transcoding. The I3C protocols support a higher bit rate than an I2C bus. In another example, a two-wire serial bus operated in accordance with conventional Inter-Integrated Circuit (I2C) protocols can be adapted to support camera control interface extension (CCIe) protocols, which uses symbol transition clocking transcoding, where data is transcoded to true ternary numbers.

Co-existence of devices over a common serial bus can present problems to designers of devices such as mobile telephones, which can include multiple Integrated Circuit (IC) devices with different communications capabilities. For example, I3C specifications define multiple HDR modes of operation which may communicate using signaling that may be misinterpreted by devices configured or capable of communicating using a different protocol. Accordingly, there is a need to provide communications protocols that enable co-existence on a common serial bus.

### SUMMARY

Certain aspects of the disclosure relate to systems, apparatus, methods and techniques that provide coexistence of protocols on a multi-wire bus. The systems, apparatus, methods and techniques can improve error detection capabilities and provide enhanced capabilities for protocols that employ hybrid ternary numbers.

According to certain aspects of the disclosure, a method of transmitting data on a multi-wire interface includes providing a plurality of data bits in a word to be transmitted on the multi-wire interface, transcoding the word to be transmitted to obtain a first multi-digit ternary number representative of the numerical value of the word to be transmitted, inserting one or more marker digits into the first multi-digit ternary number to obtain a second multi-digit ternary number, and generating a sequence of symbols. The one or more marker digits may have preconfigured values and may be inserted at preconfigured locations in the first multi-digit ternary number. Each symbol in the sequence of symbols may be generated using a digit of the second multi-digit ternary number and a preceding symbol in the sequence of symbols. Clock information may be embedded in transitions between consecutive symbols in the sequence of symbols. Each symbol may control signaling state on the multi-wire interface during a corresponding symbol transmission interval. The preconfigured values and the preconfigured locations of the one or more marker digits may be selected to prevent occurrence of I3C HDR Exit or HDR I3C Restart signaling when the sequence of symbols is transmitted on the multi-wire interface.

In some aspects, the one or more marker digits are inserted between each group of three digits in the first multi-digit ternary number. A single marker digit may be inserted in the first multi-digit ternary number. The marker digit may have one of two preconfigured values.

In one aspect, an error detection constant (EDC) is provided in the word to be transmitted. The length and a known value of the EDC are selected such that a transmission error affecting the one or more symbols in the sequence of symbols results in the EDC having a value different from the known value when decoded.

In one aspect, the first multi-digit ternary number has twelve digits. The word to be transmitted may be a binary word with twenty bits.

In one example, the method includes initiating an I3C High Data Rate (HDR) mode of operation of the serial bus, transmitting data or commands over the serial bus while operating the HDR mode of operation, and transmitting control signaling on the serial bus corresponding in duration to a sequence of 12 symbols transmitted in the HDR mode of operation. The control signaling may include HDR Exit signaling or HDR Restart signaling.

According to certain aspects of the disclosure, an apparatus includes means for coupling the apparatus to a multi-wire interface, means for providing a plurality of data bits in a word to be transmitted on the multi-wire interface, means for transcoding the word to be transmitted to obtain a first multi-digit ternary number representative of the numerical value of the word to be transmitted, means for inserting one or more marker digits into the first multi-digit ternary number to obtain a second multi-digit ternary number, and means for generating a sequence of symbols, wherein each symbol in the sequence of symbols is generated using a digit of the second multi-digit ternary number and a preceding symbol in the sequence of symbols. The means for coupling the apparatus may be configured to support data communication on the multi-wire interface. The one or more marker digits may have preconfigured values and may be inserted at preconfigured locations in the first multi-digit ternary number. Clock information may be embedded in transitions between consecutive symbols in the sequence of symbols. Each symbol may control signaling state the multi-wire interface during a corresponding symbol transmission interval. The preconfigured values and the preconfigured locations of the one or more marker digits are selected to prevent occurrence of I3C HDR Exit or HDR I3C Restart signaling when the sequence of symbols is transmitted on the multi-wire interface.

In one aspect, the one or more marker digits are inserted between each group of three digits in the first multi-digit ternary number. A single marker digit may be inserted in the first multi-digit ternary number. The marker digit may have one of two preconfigured values. The length and a known value of the EDC are selected such that a transmission error affecting the one or more symbols in the sequence of symbols results in the EDC having a value different from the known value when decoded. The first multi-digit ternary number may have twelve digits. The word to be transmitted may be a binary word with twenty bits.

According to certain aspects of the disclosure, a method of receiving data from a multi-wire interface includes receiving a sequence of symbols from the multi-wire interface, converting the sequence of symbols into a first multi-digit transition number, each digit of the first multi-digit transition number represents a transition between two consecutive symbols transmitted on the plurality of connectors, removing one or more marker digits from the first multi-digit ternary number to obtain a second multi-digit ternary number, and converting the second multi-digit ternary number into a received word that includes a plurality of data bits. The one or more marker digits may have preconfigured values and/or may be inserted at preconfigured locations in the first multi-digit ternary number.

In one aspect, the method includes comparing the one or more marker digits to one of two valid values, and determining that a transmission error has affected the sequence of symbols when any of the one or more marker digits do not have one of the two valid values. The one or more marker digits may be separated by groups of three digits in the first multi-digit ternary number. One marker digit may be present in the first multi-digit ternary number.

In one aspect, the second multi-digit ternary number has twelve digits. The received word may be a binary word with twenty bits.

In one aspect, the method includes comparing an error detection constant in the received word to a known value for error detection constants, and determining that a transmission error has affected the sequence of symbols when the error detection constant has a value different from the known value.

According to certain aspects of the disclosure, an apparatus includes means for receiving a sequence of symbols from the multi-wire interface, means for converting the sequence of symbols into a first multi-digit ternary number, each digit of the first multi-digit transition number represents a transition between two consecutive symbols transmitted on the multi-wire interface, means for removing one or more marker digits from the first multi-digit ternary number to obtain a second multi-digit ternary number, and means for converting the second multi-digit ternary number into a received word that includes a plurality of data bits. The one or more marker digits may have preconfigured values and have been inserted at preconfigured locations in the first multi-digit ternary number.

In one aspect, the means for removing the one or more marker digits may be configured to compare the one or more marker digits to one of two valid values, and determine that a transmission error has affected the sequence of symbols when any of the one or more marker digits do not have one of the two valid values.

In one aspect, the apparatus includes means for detecting a transmission error, which may be configured to compare an error detection constant in the received word to a known value for error detection constants, and determine that a transmission error has affected the sequence of symbols when the error detection constant has a value different from the known value.

In one aspect, the one or more marker digits are separated by groups of three digits in the first multi-digit ternary number. One marker digit may be present in the first multi-digit ternary number.

In one aspect, the second multi-digit ternary number may have twelve digits. The received word may be a binary word with twenty bits.

### BRIEF DESCRIPTION OF THE DRAWINGS

Various features, nature, and advantages may become apparent from the detailed description set forth below when taken in conjunction with the drawings in which like reference characters identify correspondingly throughout.

FIG. 1 depicts an apparatus employing a data link between integrated circuit (IC) devices that selectively operates according to one of a plurality of available standards.

FIG. 2 illustrates a system architecture for an apparatus employing a data link between IC devices.

FIG. 3 illustrates an example of an N! interface provided between two devices.

FIG. 4 illustrates a transmitter and a receiver that may be adapted according to certain aspects disclosed herein.

FIG. 5 illustrates an encoding scheme that may be used to control conversions between transition numbers and sequential symbols.

FIG. 6 illustrates the relationship between symbols and transition numbers in one example of a transition-encoding interface.

FIG. 7 illustrates an example of data formats in a write transaction executed over a CCIe interface.

FIG. 8 illustrates an example of data formats in a read transaction executed over a CCIe interface.

FIG. 9 illustrates an example of word configurations in a CCIe interface adapted in accordance with certain aspects disclosed herein.

FIG. 10 illustrates an example of piecewise ternary number generation implemented in accordance with certain I3C HDR protocols.

FIG. 11 illustrates frame structures associated with different modes of operation in an I3C interface.

FIG. 12 illustrates HDR Restart and HDR Exit timing in an I3C interface

FIG. 13 illustrates an example of a transmission in a true ternary interface that may be interpreted as I3C HDR Restart signaling.

FIG. 14 illustrates insertion of additional transition numbers in a set of transition numbers according to certain aspects disclosed herein.

FIG. 15 illustrates symbol slip in a transition-encoded interface and the effect of marker symbols inserted in a sequence of symbols in accordance with certain aspects disclosed herein.

FIG. 16 illustrates a pattern of 12 transition number used to indicate I3C HDR Exit and I3C HDR Restart in accordance with certain aspects disclosed herein.

FIG. 17 is a block diagram illustrating an example of an apparatus employing a processing system that may be adapted according to certain aspects disclosed herein

FIG. 18 is a flow chart of a data communications method that may be employed at a transmitter in accordance with certain aspects disclosed herein.

FIG. 19 is a diagram illustrating a first example of a hardware implementation for an apparatus used in an interface that provides symbol error detection according to certain aspects disclosed herein.

FIG. 20 is a flow chart of a data communications method that may be employed at a receiver in accordance with certain aspects disclosed herein.

FIG. 21 is a diagram illustrating a second example of a hardware implementation for an apparatus used in an interface that provides symbol error detection according to certain aspects disclosed herein.

FIG. 22 is a flowchart illustrating a method for controlling a multi-wire communications interface that employs transcoding in accordance with certain aspects disclosed herein.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures, and techniques may not be shown in detail in order not to obscure the embodiments.

Overview

Certain data transfer interfaces employ transition encoding, including 3-phase and N! multi-wire LVDS interfaces, and multi-wire single-ended interfaces including the I3C and CCIe interfaces. Transition encoding embeds clock information in signaling states transmitted over the interface. In certain instances, data is transcoded to transition numbers, where each transition number selects a next symbol to be transmitted after a current symbol. Each symbol may represent signaling state of the interface. For example, the transition number may represent an offset used to select between symbols in an ordered set of symbols that can be transmitted on the interface. By ensuring that consecutive symbols are different from one another, a change in signaling state of the interface occurs at each symbol boundary providing information used to generate a receive clock at the receiver.

I3C standards support multiple HDR modes, including a ternary-based transition-encoding mode according to an encoding scheme that may be referred to herein as a piecewise transition-encoding scheme. According to certain aspects disclosed herein a full-ternary transition-encoding scheme is implemented in which binary data is transcoded to a multi-digit ternary number, and each digit of the multi-digit ternary number is used to control signaling state transitions on a serial bus. According to certain aspects, one or more marker digits may be inserted into the ternary number to prevent occurrence of signaling when the sequence of symbols is transmitted on the multi-wire interface that may be interpreted as I3C HDR mode control signaling, including I3C HDR Exit and/or HDR I3C Restart signaling.

Example of a Device Employing Transition Encoding

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

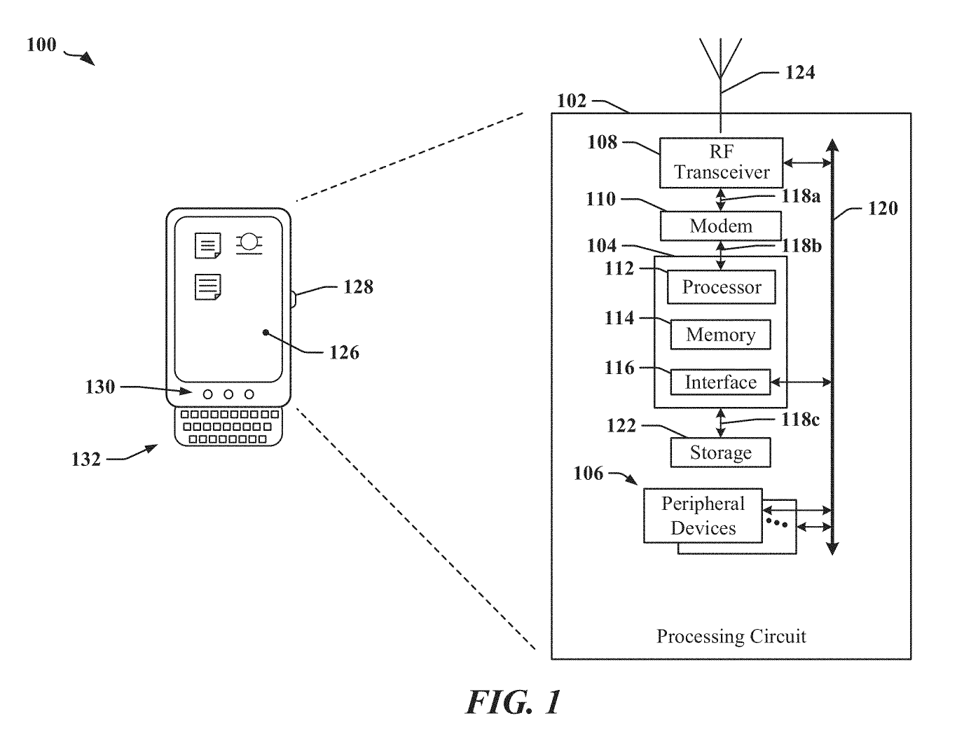

FIG. 1 illustrates an example of an apparatus 100 that may employ a data communication bus. The apparatus 100 may include a processing circuit 102 having multiple circuits or devices 104, 106, 108 and/or 110, which may be implemented in one or more ASICs and/or one or more system-on-chip (SoC) devices. In one example, the apparatus 100 may be a communication device and the processing circuit 102 may have an ASIC 104 that includes a processor 112. The ASIC 104 may implement or function as a host or application processor. The apparatus 100 may include one or more peripheral devices 106, one or more modems 110 and a transceiver 108 that enables the apparatus to communicate through an antenna 124 with a radio access network, a core access network, the Internet and/or another network. The configuration and location of the circuits or devices 104, 106, 108, 110 may vary between applications.

The circuits or devices 104, 106, 108, 110 may include a combination of sub-components. In one example, the ASIC 104 may include more than one processors 112, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 118c, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

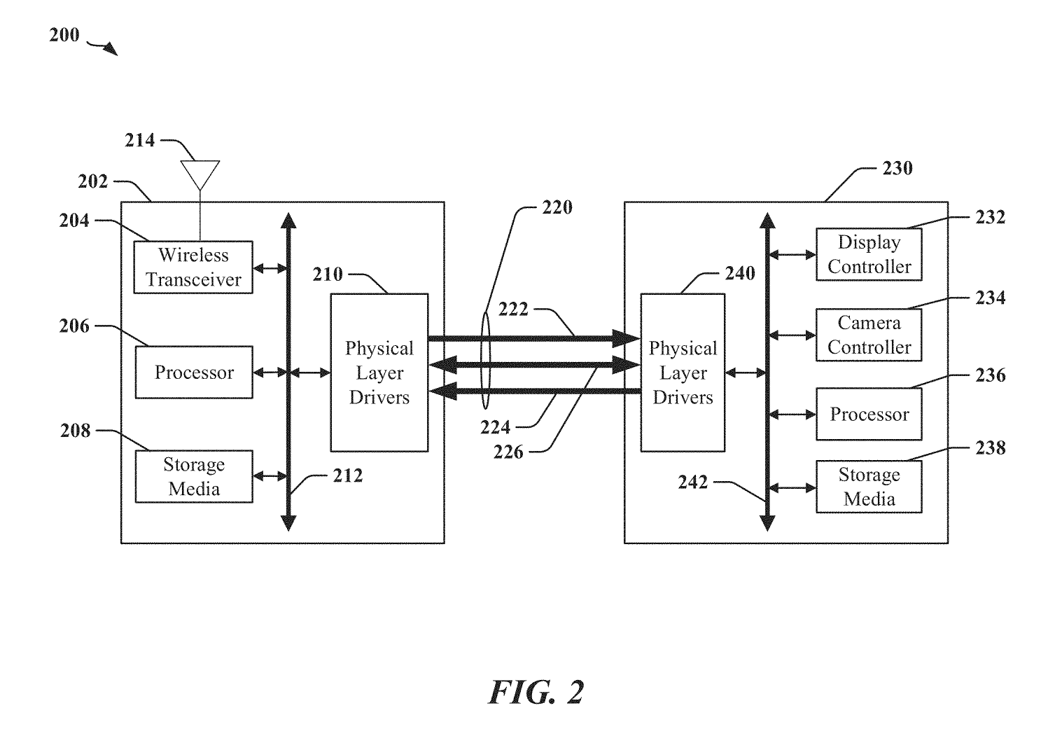

FIG. 2 illustrates certain aspects of an apparatus 200 connected to a communication link 220, where the apparatus 200 may be embodied in one or more of a mobile communication device, a mobile telephone, a mobile computing system, a cellular telephone, a notebook computer, a tablet computing device, a media player, s gaming device, or the like. The apparatus 200 may include a plurality of IC devices 202 and 230 that exchange data and control information through a communication link 220. The communication link 220 may be used to connect IC devices 202 and 230 that are located in close proximity to one another, or physically located in different parts of the apparatus 200. In one example, the communication link 220 may be provided on a chip carrier, substrate or circuit board that carries the IC devices 202 and 230. In another example, a first IC device 202 may be located in a keypad section of a flip-phone while a second IC device 230 may be located in a display section of the flip-phone. In another example, a portion of the communication link 220 may include a cable or optical connection.

The communication link 220 may include multiple channels 222, 224 and 226. One or more channels 226 may be bidirectional, and may operate in half-duplex and/or full-duplex modes. One or more channels 222 and 224 may be unidirectional. The communication link 220 may be asymmetrical, providing higher bandwidth in one direction. In one example described herein, a first communication channel 222 may provide or be referred to as a forward link while a second communication channel 224 may provide or be referred to as a reverse link. The first IC device 202 may be designated as a host system or transmitter, while the second IC device 230 may be designated as a client system or receiver, even if both IC devices 202 and 230 are configured to transmit and receive on the communication channel 222. In one example, a forward link may operate at a higher data rate when communicating data from a first IC device 202 to a second IC device 230, while a reverse link may operate at a lower data rate when communicating data from the second IC device 230 to the first IC device 202.

The IC devices 202 and 230 may each have a processor 206, 236, and/or a processing and/or computing circuit, or other such device or circuit. In one example, the first IC device 202 may perform core functions of the apparatus 200, including maintaining communications through an RF transceiver 204 and an antenna 214, while the second IC device 230 may support a user interface that manages or operates a display controller 232. The first IC device 202 or second IC device 230 may control operations of a camera or video input device using a camera controller 234. Other features supported by one or more of the IC devices 202 and 230 may include a keyboard, a voice-recognition component, and other input or output devices. The display controller 232 may include circuits and software drivers that support displays such as a liquid crystal display (LCD) panel, touch-screen display, indicators and so on. The storage media 208 and 238 may include transitory and/or non-transitory storage devices adapted to maintain instructions and data used by respective processors 206 and 236, and/or other components of the IC devices 202 and 230. Communication between each processor 206, 236 and its corresponding storage media 208 and 238 and other modules and circuits may be facilitated by one or more bus 212 and 242, respectively.

The reverse link (here, the second communication channel 224) may be operated in the same manner as the forward link (here, the first communication channel 222), and the first communication channel 222 and second communication channel 224 may be capable of transmitting at comparable speeds or at different speeds, where speed may be expressed as data transfer rate and/or clocking rates. The forward and reverse data rates may be substantially the same or differ by orders of magnitude, depending on the application. In some applications, a single bidirectional link (here, the third communication channel 226) may support communications between the first IC device 202 and the second IC device 230. The first communication channel 222 and/or second communication channel 224 may be configurable to operate in a bidirectional mode when, for example, the forward and reverse links share the same physical connections and operate in a half-duplex manner. In one example, the communication link 220 may be operated to communicate control, command and other information between the first IC device 202 and the second IC device 230 in accordance with an industry or other standard.

In one example, forward and reverse links may be configured or adapted to support a wide video graphics array (WVGA) 80 frames per second LCD driver IC without a frame buffer, delivering pixel data at 810 Mbps for display refresh. In another example, forward and reverse links may be configured or adapted to enable communications between with dynamic random access memory (DRAM), such as double data rate synchronous dynamic random access memory (SDRAM). Encoding devices 210 and/or 230 can encode multiple bits per clock transition, and multiple sets of wires can be used to transmit and receive data from the SDRAM, control signals, address signals, and so on.

Forward and reverse channels may comply or be compatible with application-specific industry standards. In one example, certain MIPI Alliance standards define physical layer interfaces between an IC device 202 that includes an application processor and an IC device 230 that controls and/or supports the camera or display in a mobile device. The MIPI Alliance standards include specifications that govern the operational characteristics of products that comply with MIPI Alliance specifications for mobile devices. The MIPI Alliance standards may define interfaces that employ complimentary metal-oxide-semiconductor (CMOS) parallel busses.

In one example, the communication link 220 of FIG. 2 may be implemented as a wired bus that includes a plurality of signal wires (denoted as N wires). The N wires may be configured to carry data encoded in symbols, where each symbol defines a signaling state of the N wires, and where clock information is embedded in a sequence of the symbols transmitted over the plurality of wires.

In one example, a two-wire serial bus may be operated in accordance with an I3C HDR protocol defined by the MIPI Alliance. In this example, binary signals are transmitted on each wire of the serial bus, and a two-bit symbol can represent the four possible signaling states of the serial bus. Each symbol occupies a symbol transmission interval. In transition encoding interfaces, signaling state changes between each pair of consecutive symbol transmission intervals allowing a clock signal to be reliably recovered based on transitions boundaries between symbol transmission intervals (symbol boundaries). Accordingly, three symbols are available at each symbol boundary for transmission in the next symbol transmission interval. The next symbol may be selected using a transition number, which is a numeric code that can have one of the values {0, 1, 2}. The transition number may be obtained by transcoding a portion of a binary word to obtain a ternary number that can be used as a transition number. The mapping scheme or algorithm used to select a next symbol based on the current symbol and the transition number may vary by application. The MIPI Alliance defines an algorithm used in an I3C HDR mode, but other algorithms may be used in different I3C HDR modes and/or in other types of transition-encoded interfaces.

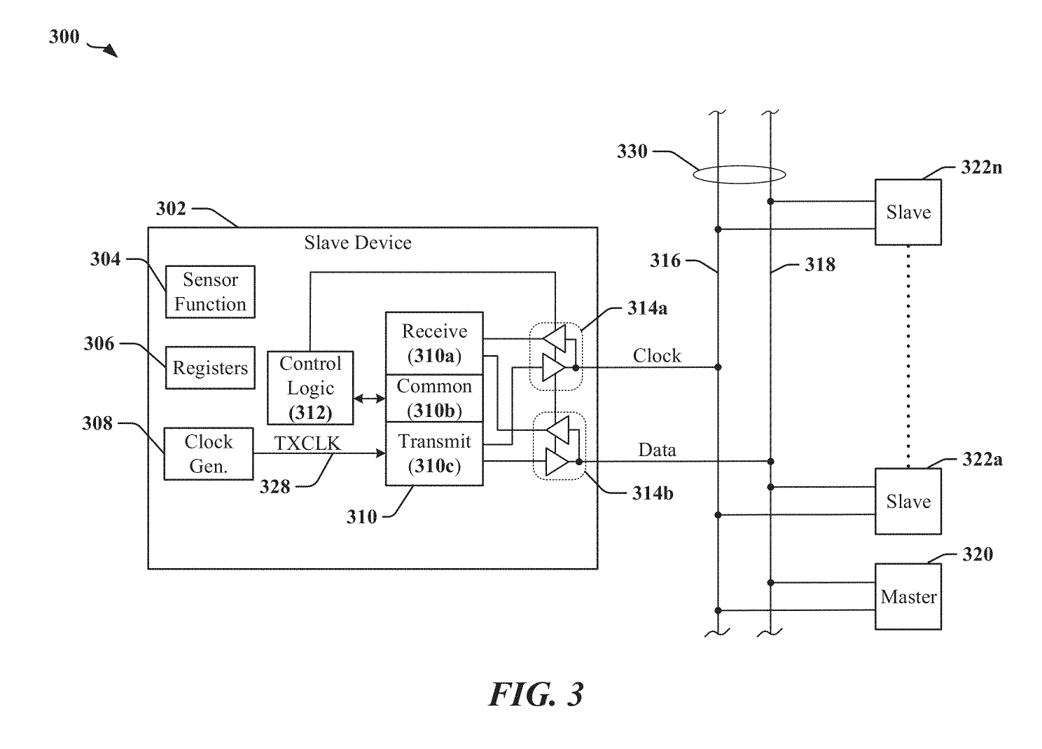

FIG. 3 illustrates certain aspects of an apparatus 300 that employs a serial bus 330 that may be configured for I2C, I3C, and/or CCIe modes of operation. The apparatus 300 may include multiple devices 302, 320 and 322a-322n, which communicate using the serial bus 330. In one example, a first slave device 302 is configured to manage, control or otherwise support an imaging device. The first slave device 302 may be adapted to provide a sensor control function 304 that manages an image sensor, for example. In addition, the first slave device 302 may include configuration registers or other storage 306, control logic 312, a transceiver 310 and line drivers/receivers 314a and 314b. The control logic 312 may include a processing circuit, a state machine, sequencer, signal processor or general-purpose processor.

The transceiver 310 may include a receiver 310a, a transmitter 310c and common circuits 310b, including timing, logic and storage circuits and/or devices. In one example, the transmitter 310c encodes and transmits data based on timing provided by a clock generation circuit 308. A conventional slave device may not have access to a clock that has a sufficiently high frequency to permit the device to achieve the indicated bit rate of the serial bus 330 when operated in certain I2C and/or I3C HDR modes. For example, an I3C HDR mode may necessitate the use of a 125 MHz or higher clock, while the sensor functions of the first slave device 302 typically do not need or use a 125 MHz or higher clock. According to certain aspects disclosed herein, however, a receiver 310a may be configured or adapted to extract a receive clock from the serial bus by generating a clock signal directly from a transition-encoded transmission using analog delay circuits that can eliminate the need for a high frequency clock and thereby conserve power during idle periods.

Transition Encoding Example

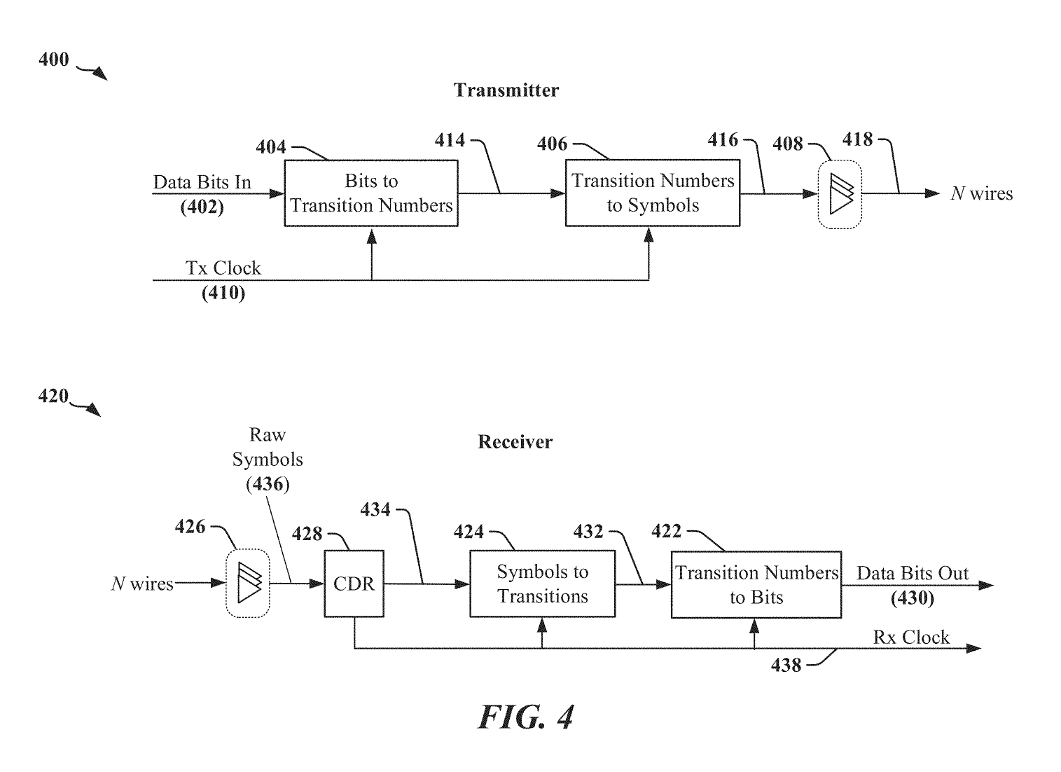

FIG. 4 is a block diagram illustrating a transmitter 400 and a receiver 420 configured according to certain aspects disclosed herein. The transmitter 400 and receiver 420 may be adapted for use with a variety of encoding techniques, including transition encoding used in I3C HDR protocols, N! and CCIe interfaces. The transmitter 400 and receiver 420 may be adapted for use with a serial bus that has two or more signal wires 418. The transmitter 400 includes a first converter 404 configured to convert data 402 into transition numbers 414. The transition numbers 414 may be used to select a next symbol for transmission based on the value of a current symbol, where the next symbol is different from a current symbol. A second converter, such as the encoder 406, receives the transition numbers and produces a sequence of symbols for transmission on the interface using suitably configured line drivers 408. No pair of consecutive symbols includes two identical symbols, ensuring that a transition of signaling state occurs in at least one of the signal wires 418 of the interface at every symbol transition. At the receiver 420, a set of line receivers 426 provides raw symbols (SI) 436 to a CDR circuit 428 that extracts a receive clock 438 and provides captured symbols (S) 434 to a circuit that converts the captured symbols 434 to transition numbers 432. The transition numbers may be decoded by a circuit 422 to provide output data 430.

In various examples, the transmitter 400 may be configured or adapted to transcode data 402 into quinary (base-5) transition numbers 414 represented by 3 bits. In the example of a two-wire serial bus, the transmitter 400 may be configured or adapted to transcode data 402 into ternary (base-3) transition numbers 414 represented by 2 bits. The transition numbers 414 may be encoded in a sequence of symbols 416 to be transmitted on the signal wires 418. The data 402 provided to the transmitter 400 may include one or more words, each word having a predefined number of bits. The first converter 404, which may be a transcoder, receives the data 402 and produces a sequence of transition numbers 414 for each data element. The sequence of transition numbers 414 may include a sufficient number of ternary numbers to encode a predefined number of bits of data, error detection and other information. The encoder 406 produces a sequence of symbols 416 that are transmitted through line drivers 408. In one example, the line drivers 408 may include open-drain output transistors. In another example, the line drivers 408 may include push-pull drivers. The output sequence of symbols 416 generated by the encoder has a transition in the state of at least one of the signal wires 418 between each pair of consecutive symbols in the sequence of symbols 416 by ensuring that no pair of consecutive symbols include two identical symbols. The availability of a transition of state in at least one of the signal wires permits a receiver 420 to extract a receive clock 438 from the sequence of symbols 416.

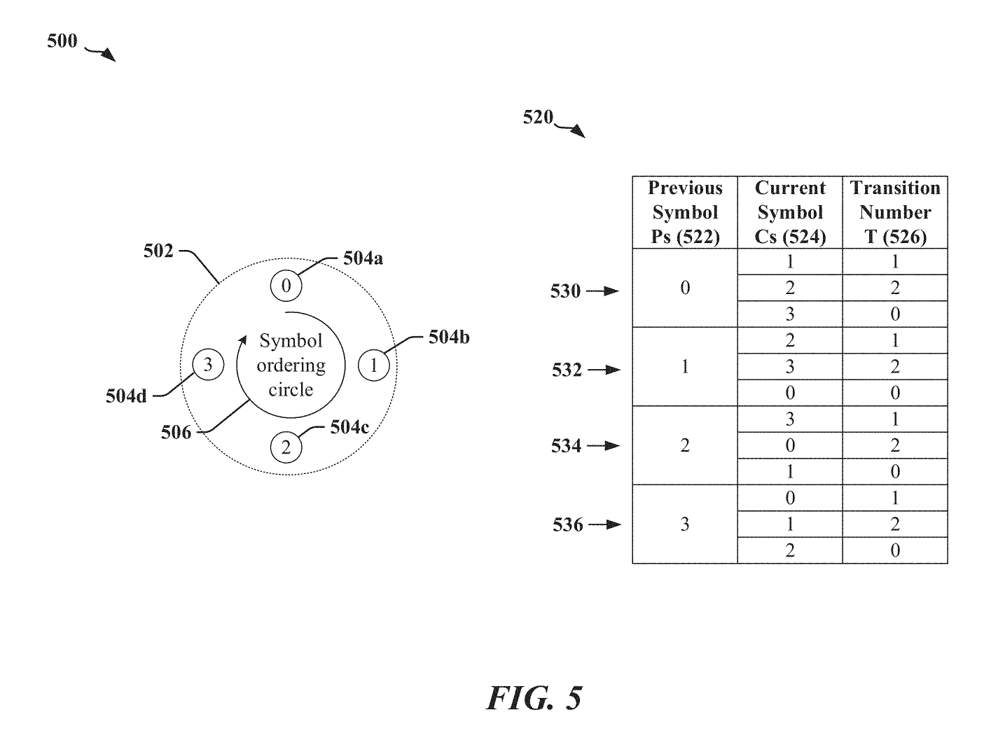

FIG. 5 is a drawing illustrating a simple example of an encoding scheme 500. Other encoding schemes may be employed. In the illustrated example, the encoding scheme may be used by the encoder 406 configured to produce a sequence of symbols 416 for transmission on a two-wire I3C HDR interface and/or a CCIe interface. The encoding scheme 500 is also used by a transcoder 424 to extract data from symbols received from signals transmitted on the signal wires 418 of the interface. In the illustrated encoding scheme 500 for a two-wire serial data communication link, the use of two signal wires 418 permits definition of 4 basic symbols S: {0, 1, 2, 3}. Any two consecutive symbols in the sequence of symbols 416, 434 have different states, and the symbol sequences 0,0, 1,1, 2,2 and 3,3 are invalid combinations of consecutive symbols. Accordingly, only 3 valid symbol transitions are available at each symbol boundary, where the symbol boundary is determined by the transmit clock and represents the point at which a first symbol (Ps) terminates and a second symbol (Cs) begins. Transmission of the first symbol, which may be referred to as the preceding or previous symbol 522, terminates when transmission of the second symbol commences, and the second symbol is then referred to as the current symbol 524.

According to certain aspects disclosed herein, the three available transitions are assigned a transition number (T) 526 for each previous symbol 522. The value of T 526 can be represented by a ternary number. In one example, the value of transition number 526 is determined using a symbol-ordering circle 502 for the encoding scheme. The symbol-ordering circle 502 allocates four locations 504a, 504b, 504c, 504d on the symbol-ordering circle 502 for the four possible symbols, and a direction of rotation 506 between the locations 504a-504d. In the depicted example, the direction of rotation 506 is clockwise. The transition number 526 may represent the separation between the valid current symbols 524 and the immediately preceding previous symbol 522. Separation may be defined as the number of steps along the direction of rotation 506 on the symbol-ordering circle 502 required to reach the current symbol 524 from the previous symbol 522. The number of steps can be expressed as a single digit base-3 number (i.e., a ternary number). It will be appreciated that a three-step difference between symbols can be represented as a 0_{base-3}. The table 520 in FIG. 5 summarizes an encoding scheme employing this approach.

At the transmitter 400, the table 520 may be used to lookup a current symbol 524 to be transmitted, given knowledge of the previous symbol 522 and an input ternary number, which is used as a transition number 526. At the receiver 420, the table 520 may be used as a lookup to determine a transition number 526 that represents the transition between the previous symbol 522 and the current symbol 524. The transition number 526 may be output as a ternary number.

The use of a transcoder that embeds clock information in a sequence of symbols can disassociate data 402 received for transmission by a transmitter 400 from the sequence of symbols 416 transmitted on signal wires 418. Consequently, a received raw symbol 436 cannot be directly decoded to obtain the data 402 provided to the transmitter 400 without consideration of at least one previously transmitted symbol.

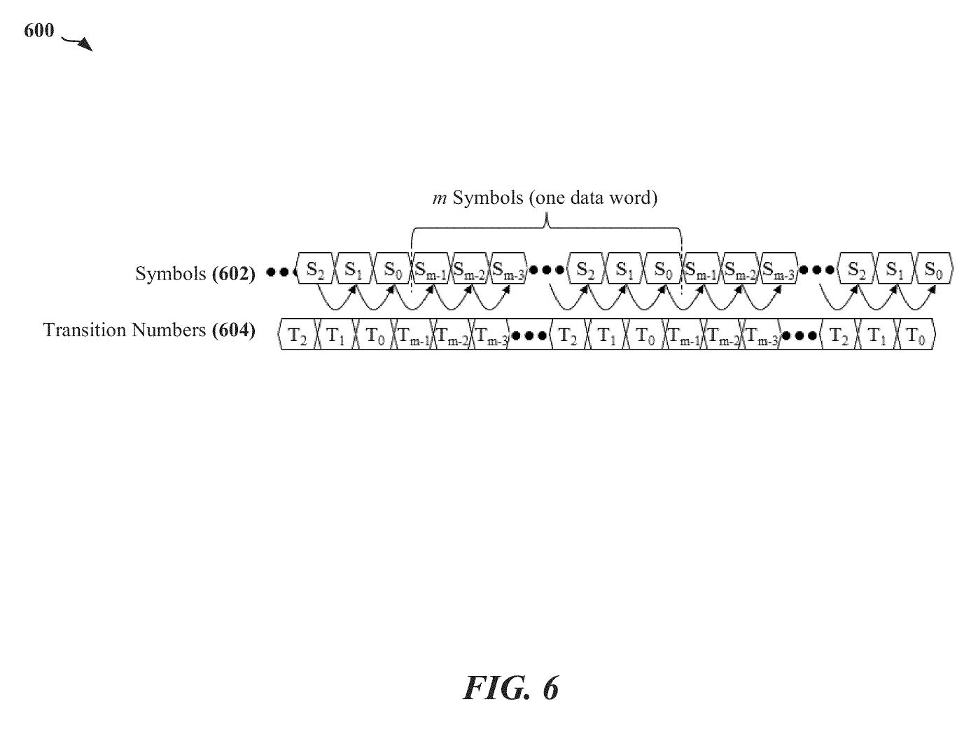

FIG. 6 is a timing diagram 600 that illustrates the relationship between symbols 602 and transition numbers 604, which may also be referred to herein as “transition symbols.” In this example, each data word is encoded in m symbols transmitted on the multi-wire interface. A word transmitted in m symbols may be decoded using the formula:

$${\sum }_{k = 0}^{m - 1} {T}_{k} {r}^{k} .$$

where Tₖ is the transition number at the k^{th} iteration, and r is number of available symbols at each transition between symbols. For example, in an example of interface that includes 6 possible signaling states, and where a self-transition is prohibited (to ensure that a receive clock can be reliably generated), r=5 states of the 6 defined states are available at each symbol transition. In a two-wire serial interface, r=3 states of the 4 defined states are available at each symbol and data words may be encoded in sequences of m=12 symbols. For a 3-wire single-ended interface, values of m=12 and r=7 may be used. For a 4-wire single-ended interface, values of m=10 and r=15 may be used.

Example of Word, Address and SID Structures in Transition-Encoded Interfaces

Data structures may be defined for transition-encoded interfaces in accordance with application needs and/or protocol requirements. For example, a data structure may be defined that supports different types of transmission, including data, address and device identifiers such as unique slave identifiers (SIDs). A data structure may be designed to support transmission of control information, signaling and commands. The data structure may take advantage of additional bits provided when binary data is mapped to transition numbers. For example, an interface that provides a symbol transition that encodes a ternary number involves a mapping to binary data that can yield control bits in additional to the desired data field. These additional bits result in an expanded transmission word format.

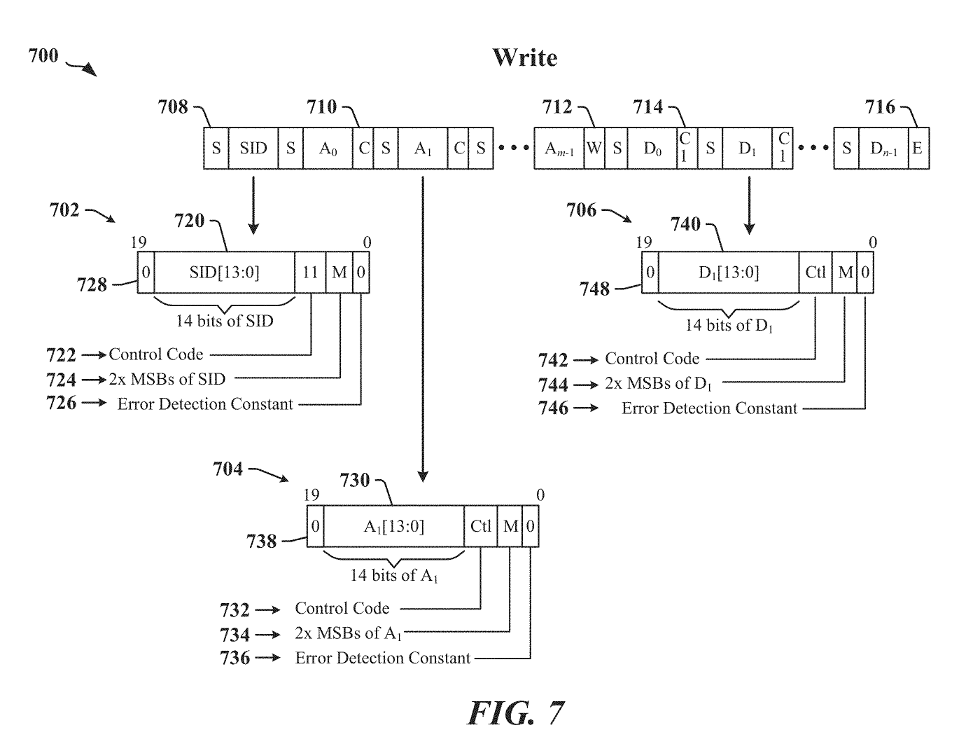

FIG. 7 illustrates an example of data formats in a write transaction 700 executed over a serial interface. The data format may be adapted for use when a serial bus is operated in an I3C HDR mode or in accordance with a CCIe protocol. A master device may transmit a slave identifier (SID 702) on the serial bus, where a device configured with the transmitted SID may respond to commands subsequently transmitted by the master device. The master device may then transmit a multi-word address including the A₁ address word 704, followed by a write bit or command 712 and multiple words of data, including the D₁ data word 706 to be written to the specified address or a sequence of addresses commencing at the specified address. The transaction includes start bits 708, bits 710, 74 that indicate that the address or data is continued, and a transaction end indicator 716.

The SID 702 commences with a 0-value bit 728, and includes 16 bits, provided as a 14-bit field 720 and 2 most significant bits (MSBs 724), separated by a 2-bit control code 722. A one-bit EDC 726 may be provided. The A₁ address word 704 commences with a 0-value bit 738, and includes 16 bits, provided as a 14-bit field 730 and 2 most significant bits (MSBs 734), separated by a 2-bit control code 732. A one-bit EDC 736 may be provided. The D₁ data word 706 commences with a 0 value 748, and includes 16 bits, provided as a 14-bit field 740 and 2 most significant bits (MSBs 744), separated by a 2-bit control code 742. A one-bit error detection constant or code 746 (EDC) may be provided.

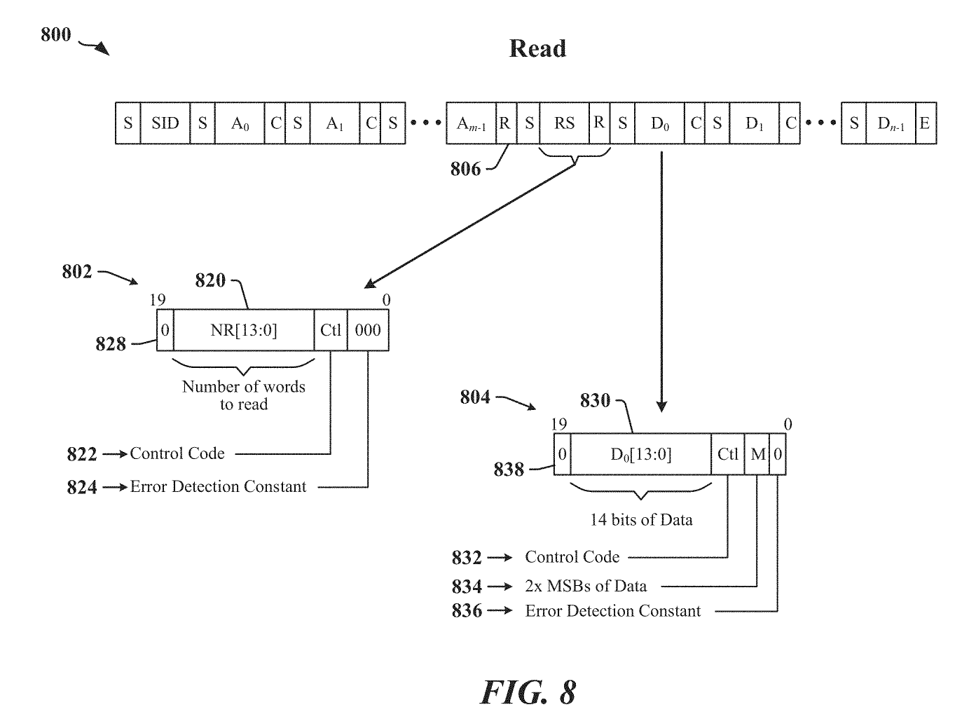

FIG. 8 illustrates a first example of data formats in a read transaction 800 executed over a serial interface. The data formats may be adapted for use when a serial bus is operated in an I3C HDR mode or in accordance with a CCIe protocol. A master device may transmit a slave identifier on the serial bus, where a device configured with the transmitted SID may respond to commands subsequently transmitted by the master device. The master device may then transmit a multi-word address, followed by a read bit or command 806. Next transmitted is a read specification word (RS word 802). The slave device responds by transmitting the number of data words specified by the RS word 802, which are read from the specified address and/or successive addresses, where the data words include the D₀ data word 804.

The RS word 802 commences with a 0-value bit 828, and includes 14 bits, provided as a 14-bit field 820 followed by a 2-bit control code 822 and a three-bit EDC 824. The D₀ data word 804 commences with a 0-value bit 838, and includes 16 bits, provided as a 14-bit field 830 and 2 most significant bits (MSBs 834), separated by a 2-bit control code 832. A one-bit EDC 836 may be provided.

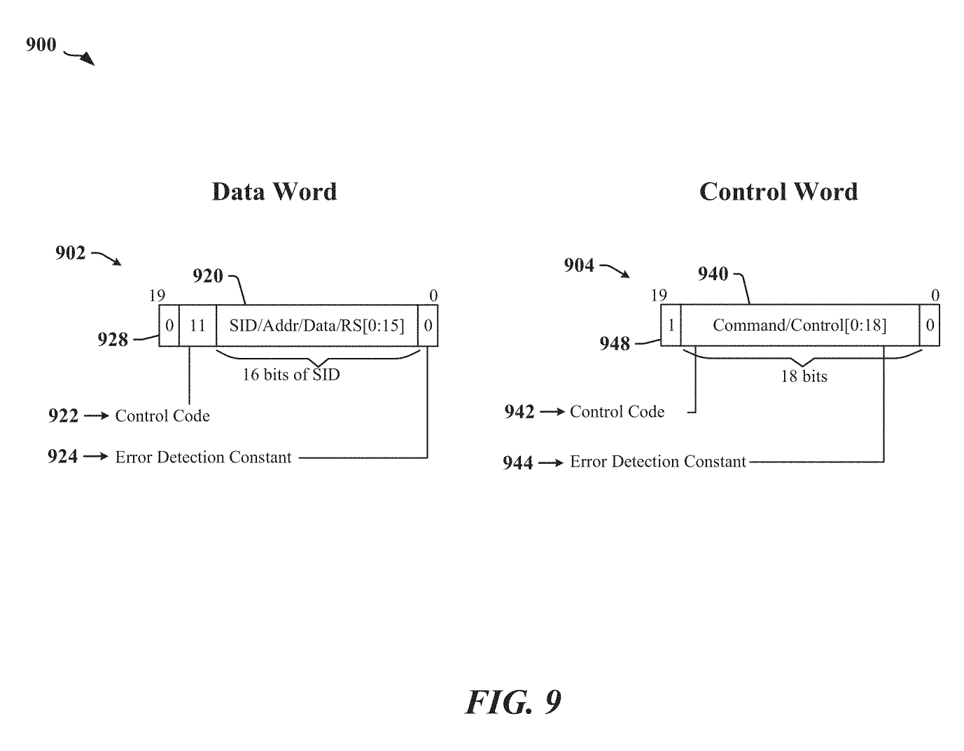

FIG. 9 illustrates a second example of word configurations 900 transmitted over a serial bus that is operated using a transition encoding protocol. In accordance with certain aspects disclosed herein, transition encoding can provide for the definition and implementation of a word structure that can implement and support a wide variety of command and control features for a communications interface. The word configurations 900 may employ a 20-bit word that supports a first word type 902 in which 18 bits 920 can be reserved for data and protocol bits with a one-bit EDC 924, and a second word type 904 that provides an 18-bit field 940 with a one-bit EDC 924 where the 18-bit field 940 can be used for bus command and control purposes or for other purposes. In the first word type 902, the MSB (Bit-19 928) is cleared to a ‘0’ value. In the second word type 904 Bit-19 948 is set to a ‘1’ value. The control words in this scheme may be referred to as Bit-19 control words. In some examples, control words can be transmitted to create certain signaling conditions on a serial bus, provide in-band interrupt opportunities, and support low-power modes of operation. Certain uses of the control words relate to supporting coexistence on a communication link which couples devices that have different capabilities.

In a two-wire transition-encoded interface, data may be transcoded to ternary transition numbers, where each digit of a ternary transition number is used to select a next symbol for transmission based on the value of the immediately preceding symbol. In one example, 20-bit data words may be transcoded to ternary numbers that include 12 ternary digits used to select a sequence of 12 symbols for transmission. This type of ternary encoding may be referred to as true ternary encoding. As indicated in reference to FIG. 6, for a sequence of m symbols data is encoded in transition numbers of base r, the relationship between data and transition numbers may be characterized as:

$$data = {\sum }_{k = 0}^{m - 1} {T}_{k} {r}^{k} .$$

where k has a value between 0 and m−1. Each transition number (Tₖ) corresponds to the transition between a pair of consecutively transmitted symbols. For the two-wire transition-encoded interface using ternary transition numbers, r=3 and m=12. By way of example, the relationship between the decimal number 13 and an equivalent ternary number may be represented as:

data=(Tₖ₌₀×3⁰)+(Tₖ₌₁×3¹)+(Tₖ₌₂×3²)

13=(1×1)+(1×3)+(1×9).

In this example, the ternary number 111 is equivalent to decimal 13.

In certain examples, a two-wire bus provides 3 available symbols at each transition between consecutive symbols, and the transition numbers may be expressed as ternary numbers (base-3). Devices adapted to communicate using transition encoding protocols may be coupled to a bus that connects I2C, I3C and other types of device. Certain of these devices, including some I3C devices, perform piecewise ternary encoding on data to be transmitted over a serial bus.

Piecewise Ternary Transition-Encoded Interfaces

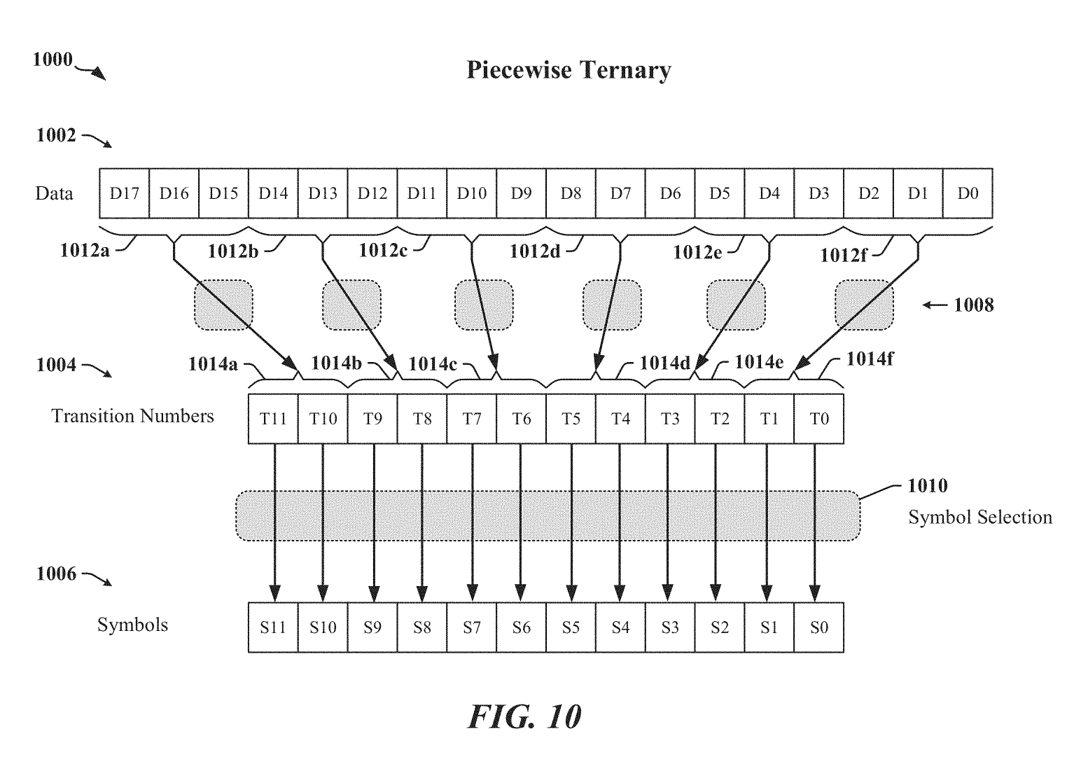

FIG. 10 illustrates an example 1000 of piecewise ternary number generation to obtain a hybrid multi-digit ternary transition number 1004 that can be used to select a set of symbols 1006 according to an I3C high data rate (HDR) protocol. A plurality of sub-functions 1008 operate on different portions 1012a-1012f of the binary data word 1002 to produce a plurality of 2-digit ternary numbers 1014a-1014f. The 2-digit ternary numbers 1014a-1014f may be assembled to obtain the hybrid multi-digit ternary transition number 1004. In the example, the data word 1002 is expressed as a binary number and divided into 3-bit portions 1012a-1012f, where each 3-bit portion 1012a-1012f is converted to a 2-digit ternary number. Each digit of the hybrid multi-digit ternary transition number 1004 is provided to symbol selection logic 1010 that produces the set of symbols 1006.

Each 2-digit ternary number 1014a-1014f is calculated by one of the sub-functions 1008 in accordance with:

$$data = {\sum }_{k = 0}^{1} {T}_{k} {3}^{k} .$$

In the example of the decimal number 13, a piecewise ternary number generator represents the number as the binary number 001101. The piecewise ternary number generator separates the binary number into the two portions, which are 001 and 101. These portions are independently converted to the 2-digit ternary numbers 01 and 12. The 2-digit ternary numbers are assembled into the hybrid multi-digit ternary number 0112. For the purposes of comparison, a true ternary conversion of decimal 13 yields the ternary number 111.

The piecewise ternary number generation employed by some I3C implementations provides for encoding of 18-bit words. As discussed herein, 2-bit ternary numbers are generated from 3-bit binary portions of data. The 2-bit ternary numbers provide 9 permutations for encoding 8 possible 3-bit data values, representing a loss of encoding efficiency. Accordingly, transition encoding protocols that use piecewise ternary number generation do not have sufficient bits to support Bit-19 control words or error detection using an EDC while transmitting 16-bit data.

In addition to differences in transition number generation, I3C protocols define signaling that may conflict with signaling generated when enhanced protocols such as CCIe are active on the serial bus. Signaling conflicts may be exhibited as coexistence issues, where less capable I3C devices interpret CCIe signaling as I3C control signals.

Supporting Full-Ternary Transition-Encoded in an I3C Interface

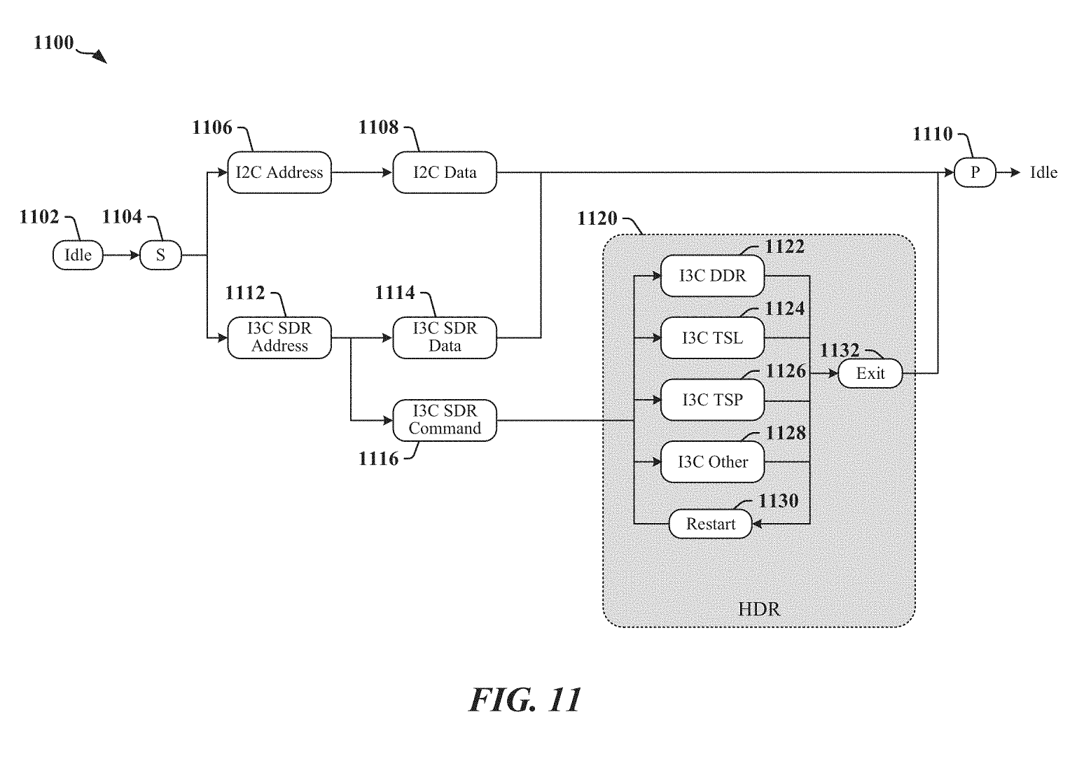

FIG. 11 illustrates frame structures 1100 associated with different modes of operation in an I3C interface. A serial bus may exit from an idle state 1102 when an I2C start condition 1104 is transmitted by a bus master. The bus master may select between legacy I2C protocols and I3C protocols. In a first mode, the bus master may execute one or more I2C transactions by transmitting an I2C address 1106 followed by I2C data 1108. After completing the transactions, the bus master transmits a stop condition 1110, and the bus may return to the idle state 1102.

In a second mode, the bus master may initiate one or more I3C transactions by transmitting an I3C address 1112. The bus master may then transmit single data rate (SDR) data 1114 before transmitting a stop condition 1110, causing the bus to return to the idle state 1102.

In a third mode, the bus master may initiate one or more I3C transactions by transmitting an I3C address 1112 followed by one or more SDR commands 1116 that cause receiving devices to enter HDR mode 1120. The SDR commands 1116 may specify a type 1122, 1124, 1126, 1128 of HDR mode of operation. HDR types include double data rate (DDR) type 1122, where data is transmitted on rising and falling edges of a clock signal, and ternary (TSL type 1124 and TSP type 1126). In some implementations, other HDR types 1128 may be employed. In some implementations, the bus may switch between types 1122, 1124, 1126, 1128 while remaining in the HDR mode 1120, using HDR Restart signaling 1130. HDR Exit signaling 1132 may be transmitted to cause the bus to exit the HDR mode 1120. After exiting the HDR mode 1120 the bus master may transmit a stop condition 1110 to cause the bus to return to the idle state 1102. HDR Restart signaling 1130 may be transmitted between frames in various HDR modes 1120. HDR Exit signaling 1132 and HDR Restart signaling 1130 is recognized by HDR-capable devices, whether or not the HDR-capable devices support the current type 1122, 1124, 1126, 1128 of HDR mode in which the HDR Exit signaling 1132 or HDR Restart signaling 1130 was transmitted.

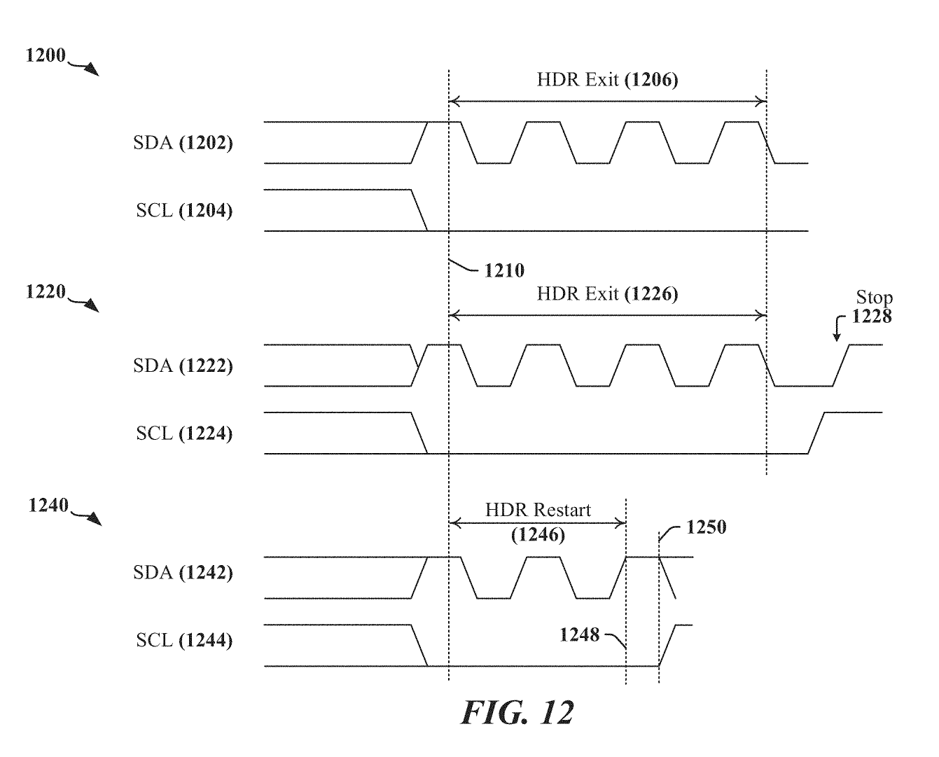

FIG. 12 illustrates timing in an I3C interface. A first example 1200 illustrates signaling on SDA 1202 and SCL 1204 that indicate an HDR Exit 1206. In one example, the HDR Exit 1206 is signaled when seven edges are transmitted on SDA 1202 while SCL 1204 remains in a low signaling state. A second example 1220 illustrates signaling on SDA 1222 and SCL 1224 that indicate an HDR Exit 1226 followed by a stop condition 1228. In this example, HDR Exit 1226 is signaled when seven edges are transmitted on SDA 1202 while SCL 1204 remains in a low signaling state. The stop condition 1228 follows I2C protocols. A third example 1240 illustrates signaling on SDA 1242 and SCL 1244 that indicate an HDR Restart 1246. The HDR Restart 1246 is signaled when four edges are transmitted on SDA 1202 while SCL 1204 remains in a low signaling state, followed by a rising edge in SCL 1204. After the fourth edge 1248 and at the rising edge in SCL 1204, devices may monitor the bus to determine whether symbols are being transmitted at the start of the next symbol interval 1250.

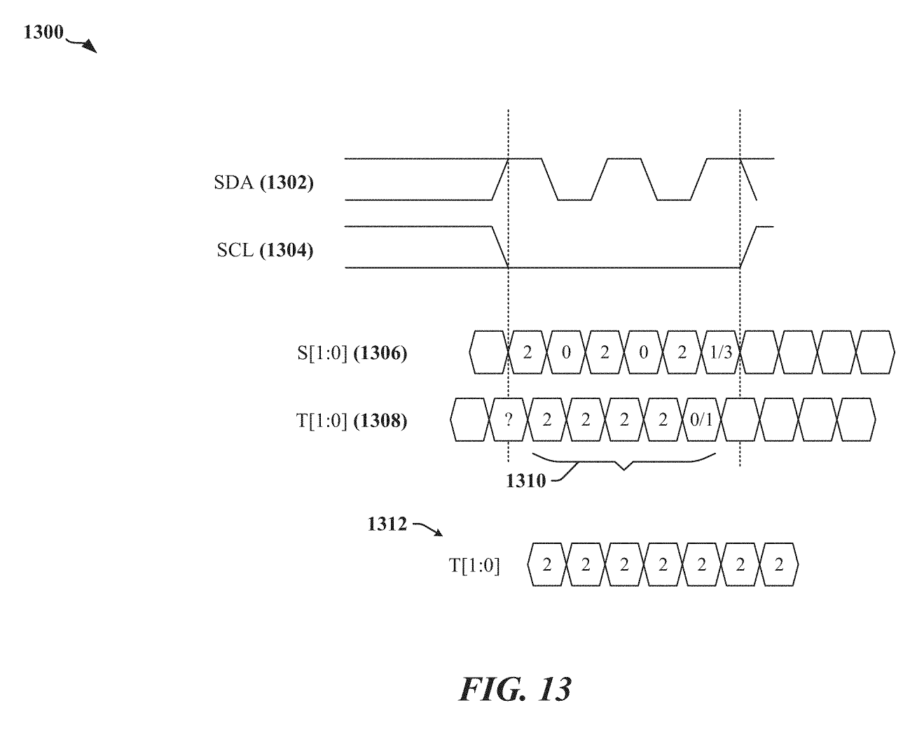

FIG. 13 illustrates an example of a transmission 1300 in a true ternary interface that may be interpreted as I3C TSP or TSL restart signaling transmitted on SDA 1302 and SCL 1304. The true ternary interface may operate in accordance with CCIe protocols, for example, and may transmit a sequence of symbols 1306 generated from transition numbers 1308. For comparison, the transition numbers 1312 that generate an HDR Exit pattern are shown. A CCIe transmitter producing certain sequences of transition numbers 1310, 1312 may cause an inadvertent HDR Restart or HDR Exit.

Techniques for Avoiding HDR Restart or HDR Exit

A transmitter adapted to operate in a full-ternary mode of communication according to certain aspects disclosed herein may insert marker symbols in sequences of symbols that encode data and control information.

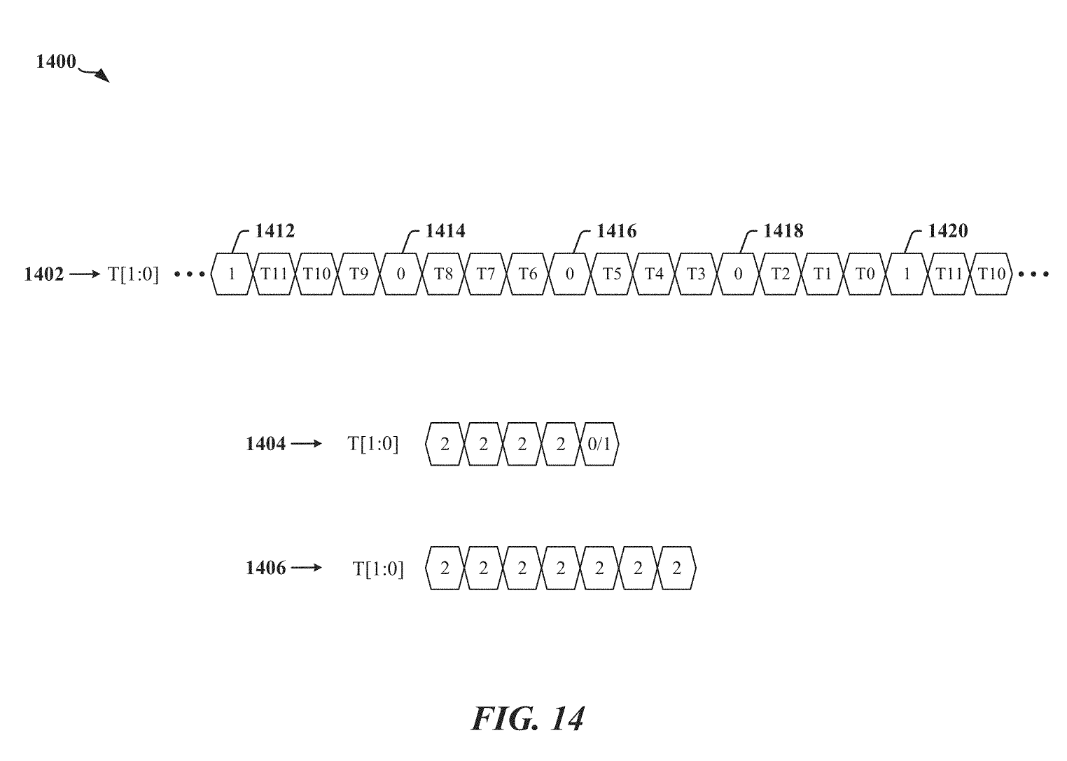

FIG. 14 illustrates one example in which additional transition numbers 1412, 1414, 1416, 1418, 1420 (marker transition symbols) may be inserted in a set of transition numbers 1402 to avoid the occurrence of a sequence of transition numbers 1404 associated with an I3C HDR Restart signaling pattern, and to avoid the occurrence of a sequence of transition numbers 1406 associated with an I3C HDR Exit signaling pattern. In the example, an additional transition number 1412, 1414, 1416, 1418, 1420 is inserted after every three transition numbers. In one example, the additional transition number 1412, 1414, 1416, 1418, 1420 may have a value of ternary ‘0’ or ternary ‘1’.

The use of marker transition symbols to avoid the occurrence of aliased I3C HDR start or I3C HDR Exit signaling may provide other benefits based on the knowledge of the receiver regarding placement of marker transition symbols. In one example, marker transition symbols can enable or enhance detection of symbol slip conditions.

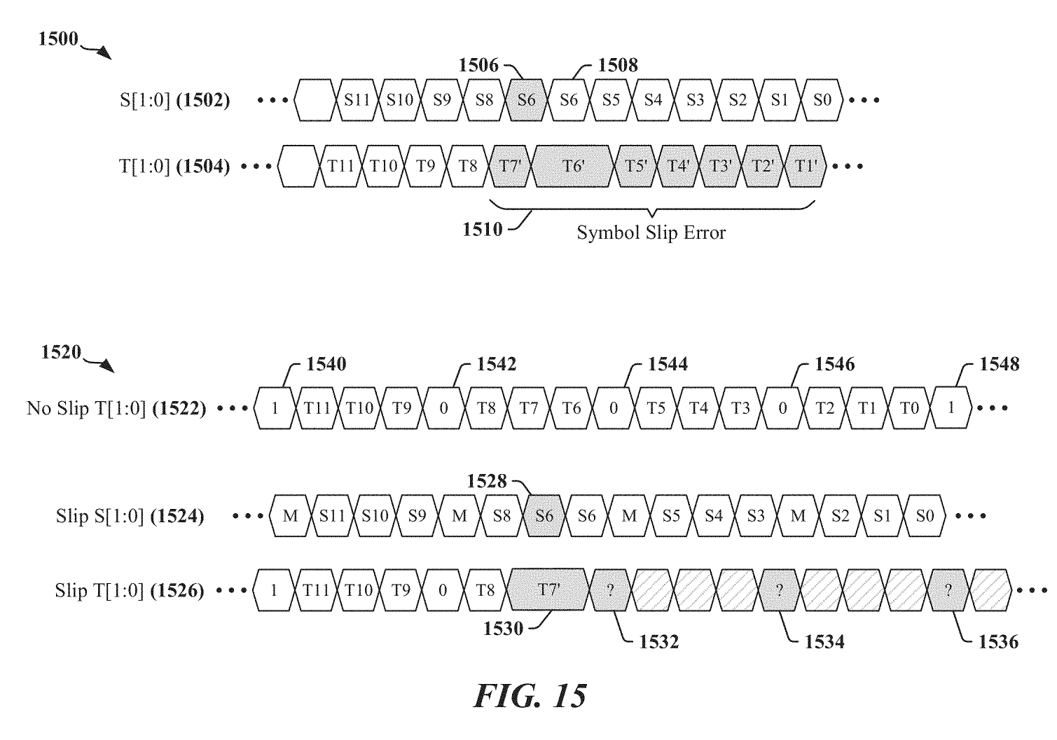

FIG. 15 illustrates a first example 1500 of symbol slip. In this example, the symbol slip occurs in a transition-encoded interface that does not use marker transition symbols. Symbol slip can occur when clock recovery circuits either miss a transition between symbols or falsely detect a transition. In the first example 1500, the sequence of symbols 1502 exhibits a symbol slip when duplicated symbols 1506, 1508 are detected (Symbol S7 was missed). The resultant error 1510 in the set of transition numbers 1504 extends over the transition numbers generated after occurrence of the error in the sequence of symbols 1502.

The second example 1520 in FIG. 15 illustrates symbol slip in a transition-encoded interface when marker transition symbols 1540, 1542, 1544, 1546, 1548 are inserted in the sequence of symbols 1522. In this example 1520, the sequence of symbols 1522 exhibits a symbol slip when a duplicated symbol 1528 is detected in place of Symbol S7. The error may be quickly detected because the receiver expects a known transition number associated with every 4 symbols. There is a high probability that symbol slip can be detected in the set of transition numbers 1526. The probability of detection increases with every fourth symbol after the slip. The probability of slip detection (P_{detect}) may be calculated as:

P_{detect}=1−1/3ⁿ,

where n is the number of marker transition symbols occurring after the slip. For a word encoded in 12 symbols with 4 markers, slip detection rate may be at least 98.8%. In a full-ternary transition encoding interface, a 3-bit EDC may be transmitted that is capable of detecting symbol slip and other errors. When marker transition symbols are used with a 3-bit EDC, the slip detection rate may be calculated as P_{detect}=1−1/3⁴×1/8=99.8% in one word transmission period.

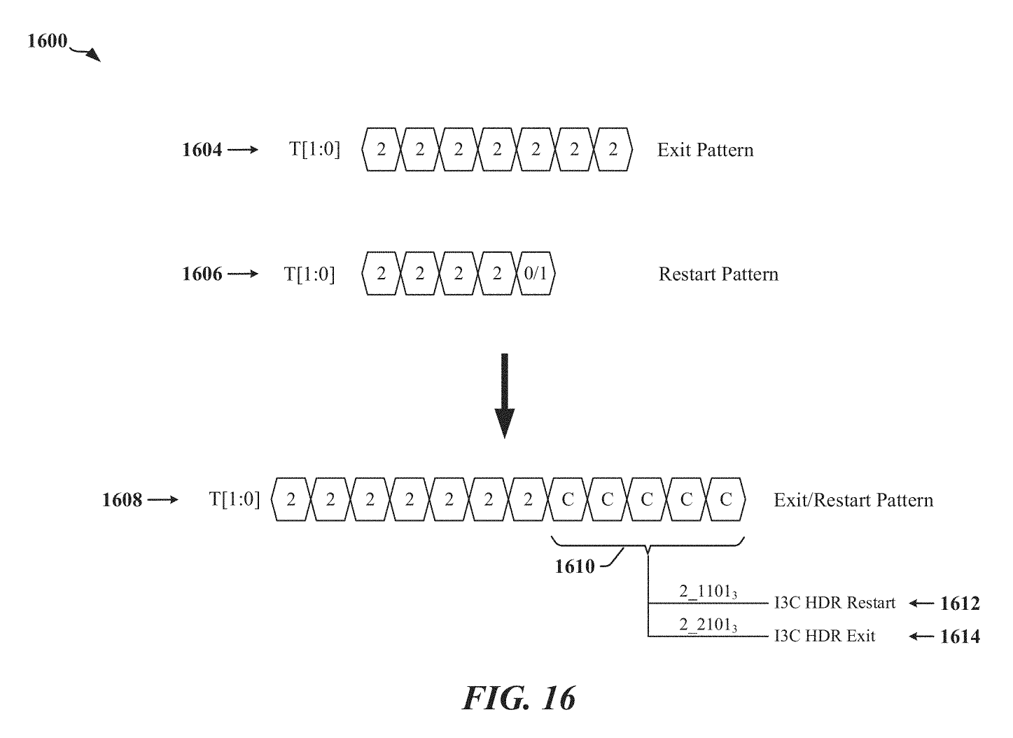

FIG. 16 illustrates one example 1600 in which a pattern of 12 transition number may be used to indicate I3C HDR Exit and I3C HDR Restart. The conventional I3C HDR Exit pattern 1604 and I3C HDR Restart pattern 1606 may be implemented using an HDR Exit/Restart pattern 1608 that includes the HDR Exit pattern 1604 and additional transition numbers 1610 that indicate a change in I3C HDR mode. The HDR Exit/Restart pattern 1608 may be configured to provide support for additional features, including in-band interrupt capability within I3C HDR active modes. Conventionally, I3C permits in-band interrupt only when the bus is idle. In one example, an in-band interrupt may be employed where an interrupting device can drive SDA during one or two of the final symbols in the HDR Exit/Restart pattern 1608.

According to certain aspects, an interface that accommodates full-ternary modes of communication according to certain aspects disclosed herein can increase use of HDR Exit and HDR Restart signaling patterns, and may insert marker symbols in sequences of symbols that encode data and control information. In some implementations, the interface that accommodates full-ternary modes of communication may use longer HDR Exit and HDR Restart signaling patterns. The combination of increased HDR Exit and HDR Restart signaling patterns with inserted markers can improve slip detection and provide support for in-band interrupts. A 12-symbol HDR Exit and HDR Restart patterns may be implemented with insertion of one or more marker in every word transmission period.

Examples of Processing Circuits and Methods

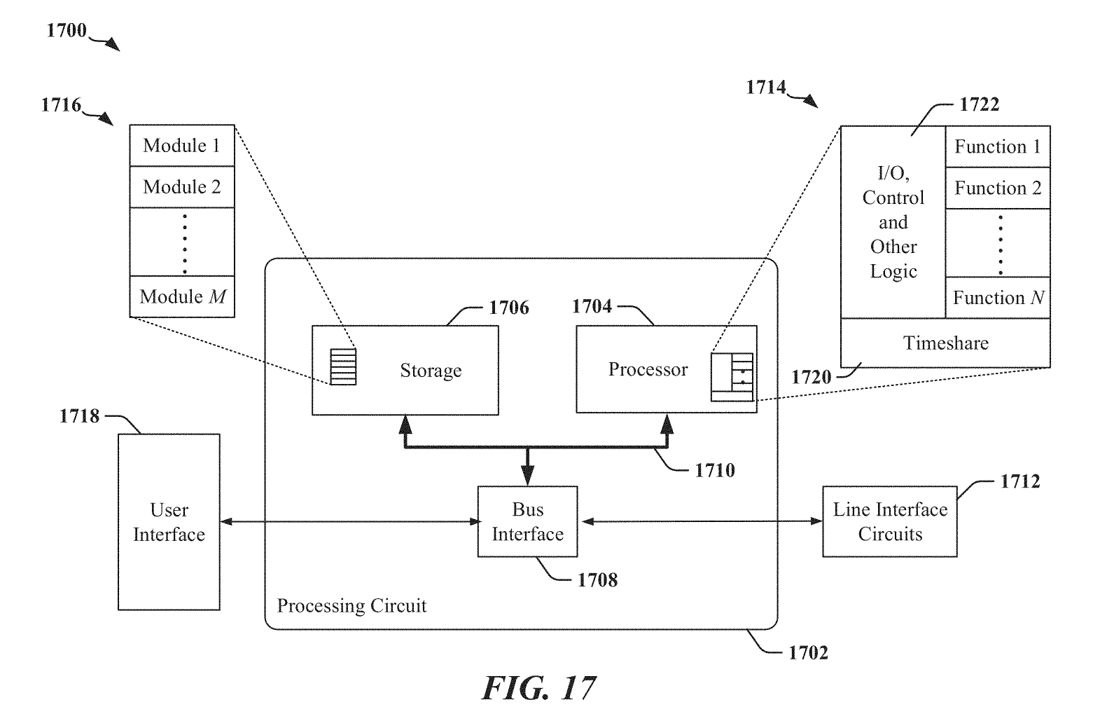

FIG. 17 is a conceptual diagram illustrating a simplified example of a hardware implementation for an apparatus 1700 employing a processing circuit 1702 that may be configured to perform one or more functions disclosed herein. In accordance with various aspects of the disclosure, an element, or any portion of an element, or any combination of elements as disclosed herein may be implemented using the processing circuit 1702. The processing circuit 1702 may include one or more processors 1704 that are controlled by some combination of hardware and software modules. Examples of processors 1704 include microprocessors, microcontrollers, digital signal processors (DSPs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 1704 may include specialized processors that perform specific functions, and that may be configured, augmented or controlled by one of the software modules 1716. The one or more processors 1704 may be configured through a combination of software modules 1716 loaded during initialization, and further configured by loading or unloading one or more software modules 1716 during operation.

In the illustrated example, the processing circuit 1702 may be implemented with a bus architecture, represented generally by the bus 1710. The bus 1710 may include any number of interconnecting buses and bridges depending on the specific application of the processing circuit 1702 and the overall design constraints. The bus 1710 links together various circuits including the one or more processors 1704, and storage 1706. Storage 1706 may include memory devices and mass storage devices, and may be referred to herein as computer-readable media and/or processor-readable media. The bus 1710 may also link various other circuits such as timing sources, timers, peripherals, voltage regulators, and power management circuits. A bus interface 1708 may provide an interface between the bus 1710 and one or more transceivers 1712. A transceiver 1712 may be provided for each networking technology supported by the processing circuit. In some instances, multiple networking technologies may share some or all of the circuitry or processing modules found in a transceiver 1712. Each transceiver 1712 provides a means for communicating with various other apparatus over a transmission medium. Depending upon the nature of the apparatus 1700, a user interface 1718 (e.g., keypad, display, touch interface, speaker, microphone, joystick) may also be provided, and may be communicatively coupled to the bus 1710 directly or through the bus interface 1708.

A processor 1704 may be responsible for managing the bus 1710 and for general processing that may include the execution of software stored in a processor-readable medium that may include the storage 1706. In this respect, the processing circuit 1702, including the processor 1704, may be used to implement any of the methods, functions and techniques disclosed herein. The storage 1706 may be used for storing data that is manipulated by the processor 1704 when executing software, and the software may be configured to implement any one of the methods disclosed herein.

One or more processors 1704 in the processing circuit 1702 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in processor-readable in the storage 1706 or in an external processor-readable. The external processor-readable and/or storage 1706 may include a non-transitory processor-readable. A non-transitory processor-readable includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The processor-readable medium and/or storage 1706 may also include, by way of example, a carrier wave, a transmission line, and any other suitable medium for transmitting software and/or instructions that may be accessed and read by a computer. Processor-readable medium and/or the storage 1706 may reside in the processing circuit 1702, in the processor 1704, external to the processing circuit 1702, or be distributed across multiple entities including the processing circuit 1702. The processor-readable medium and/or storage 1706 may be embodied in a computer program product. By way of example, a computer program product may include a processor-readable medium in packaging materials. Those skilled in the art will recognize how best to implement the described functionality presented throughout this disclosure depending on the particular application and the overall design constraints imposed on the overall system.

The storage 1706 may maintain software maintained and/or organized in loadable code segments, modules, applications, programs, etc., which may be referred to herein as software modules 1716. Each of the software modules 1716 may include instructions and data that, when installed or loaded on the processing circuit 1702 and executed by the one or more processors 1704, contribute to a run-time image 1714 that controls the operation of the one or more processors 1704. When executed, certain instructions may cause the processing circuit 1702 to perform functions in accordance with certain methods, algorithms and processes described herein.

Some of the software modules 1716 may be loaded during initialization of the processing circuit 1702, and these software modules 1716 may configure the processing circuit 1702 to enable performance of the various functions disclosed herein. For example, some software modules 1716 may configure internal devices and/or logic circuits 1722 of the processor 1704, and may manage access to external devices such as the transceiver 1712, the bus interface 1708, the user interface 1718, timers, mathematical coprocessors, and so on. The software modules 1716 may include a control program and/or an operating system that interacts with interrupt handlers and device drivers, and that controls access to various resources provided by the processing circuit 1702. The resources may include memory, processing time, access to the transceiver 1712, the user interface 1718, and so on.

One or more processors 1704 of the processing circuit 1702 may be multifunctional, whereby some of the software modules 1716 are loaded and configured to perform different functions or different instances of the same function. The one or more processors 1704 may additionally be adapted to manage background tasks initiated in response to inputs from the user interface 1718, the transceiver 1712, and device drivers, for example. To support the performance of multiple functions, the one or more processors 1704 may be configured to provide a multitasking environment, whereby each of a plurality of functions is implemented as a set of tasks serviced by the one or more processors 1704 as needed or desired. In one example, the multitasking environment may be implemented using a timesharing program 1720 that passes control of a processor 1704 between different tasks, whereby each task returns control of the one or more processors 1704 to the timesharing program 1720 upon completion of any outstanding operations and/or in response to an input such as an interrupt. When a task has control of the one or more processors 1704, the processing circuit is effectively specialized for the purposes addressed by the function associated with the controlling task. The timesharing program 1720 may include an operating system, a main loop that transfers control on a round-robin basis, a function that allocates control of the one or more processors 1704 in accordance with a prioritization of the functions, and/or an interrupt driven main loop that responds to external events by providing control of the one or more processors 1704 to a handling function.

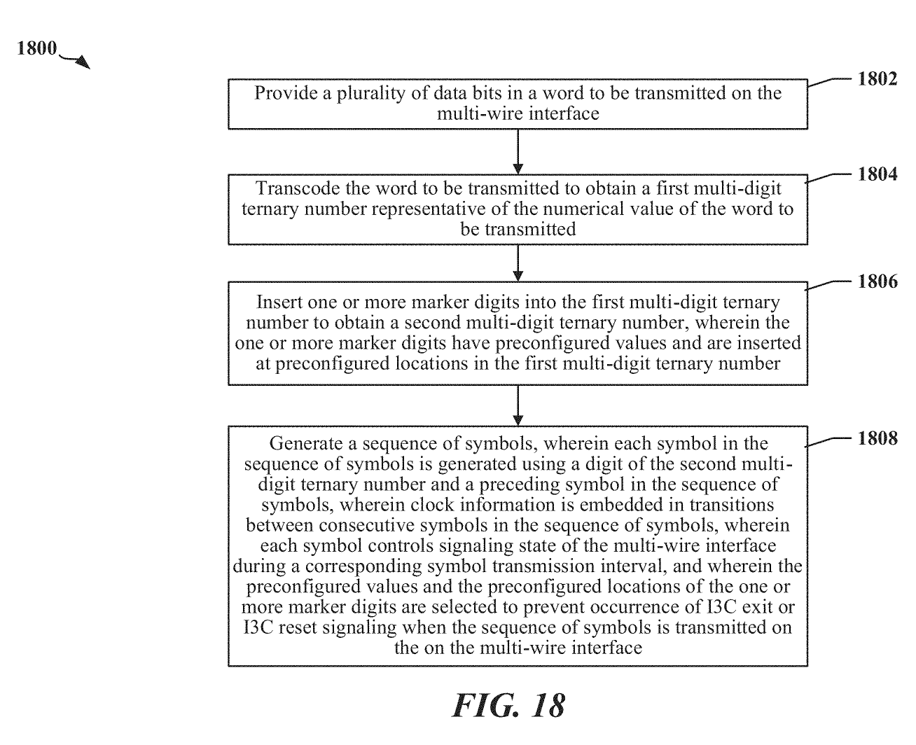

FIG. 18 is a flowchart 1800 illustrating a method for data communications on a multi-wire communications interface that employs transcoding. The method may be performed using a transmitting circuit.

At block 1802, the transmitting circuit may provide a plurality of data bits in a word to be transmitted on the multi-wire interface;

At block 1804, the transmitting circuit may transcode the word to be transmitted to obtain a first multi-digit ternary number representative of the numerical value of the word to be transmitted.

At block 1806, the transmitting circuit may insert one or more marker digits into the first multi-digit ternary number to obtain a second multi-digit ternary number. The one or more marker digits may have preconfigured values. The one or more marker digits may be inserted at preconfigured locations in the first multi-digit ternary number.

At block 1808, the transmitting circuit may generate a sequence of symbols. Each symbol in the sequence of symbols may be generated using a digit of the second multi-digit ternary number and a preceding symbol in the sequence of symbols. Clock information may be embedded in transitions between consecutive symbols in the sequence of symbols. Each symbol may control signaling state of the multi-wire interface during a corresponding symbol transmission interval. The preconfigured values and the preconfigured locations of the one or more marker digits may be selected to prevent occurrence of I3C HDR Exit or HDR I3C Restart signaling when the sequence of symbols is transmitted on the multi-wire interface.

In one example, the one or more marker digits are inserted between each group of three digits in the first multi-digit ternary number. In another example, a single marker digit is inserted in the first multi-digit ternary number. The marker digit may have one of two preconfigured values.

In some instances, an EDC may be provided in the word to be transmitted. The length and the known value of the EDC may be selected such that a transmission error affecting the one or more symbols in the sequence of symbols results in the EDC having a value different from the known value when decoded.

In one example, the first multi-digit ternary number has twelve digits. In some examples, the word to be transmitted may be a binary word with twenty bits.

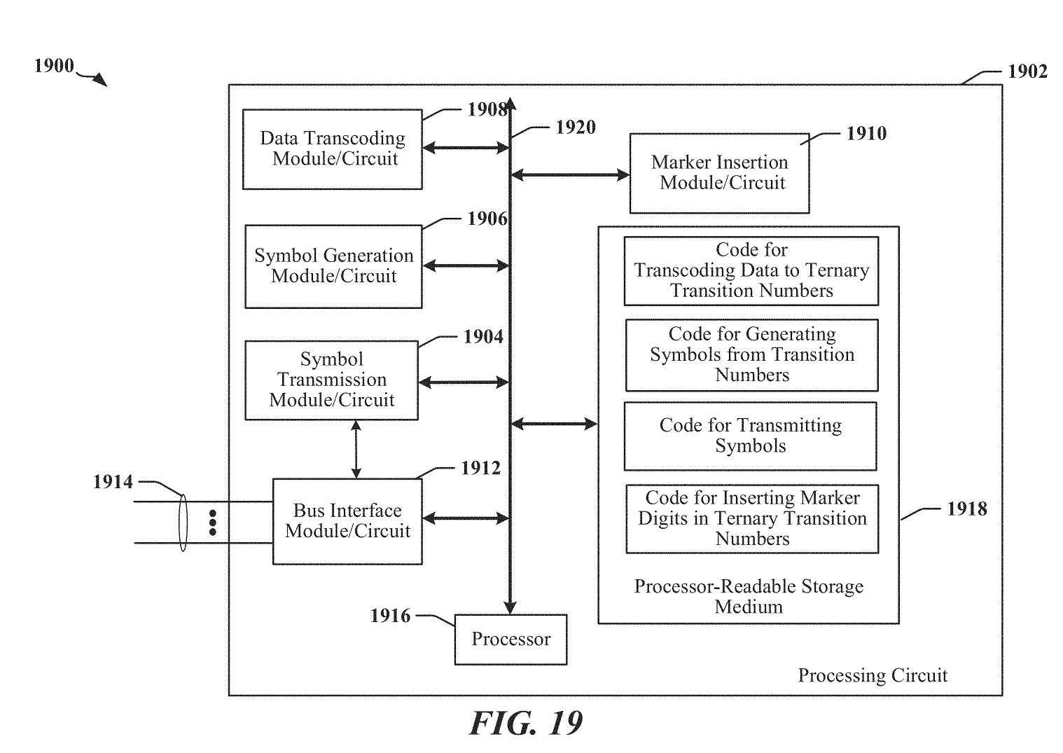

FIG. 19 is a conceptual diagram illustrating an example of a hardware implementation for an apparatus 1900 employing a processing circuit 1902. In this example, the processing circuit 1902 may be implemented with a bus architecture, represented generally by the bus 1916. The bus 1916 may include any number of interconnecting buses and bridges depending on the specific application of the processing circuit 1902 and the overall design constraints. The bus 1916 links together various circuits including one or more processors, represented generally by the processor 1912, and processor-readable media, represented generally by the processor-readable storage medium 1914. The bus 1916 may also link various other circuits such as timing sources, timers, peripherals, voltage regulators, and power management circuits. A transceiver or communications interface 1918 provides a means for communicating with various other apparatus over a multi-wire interface 1920. Depending upon the nature of the apparatus, a user interface (e.g., keypad, display, speaker, microphone, joystick) may also be provided. One or more clock generation circuits may be provided within the processing circuit 1902 or controlled by the processing circuit 1902 and/or one or more processors 1912. In one example, the clock generation circuits may include one or more crystal oscillators, one or more phase-locked loop devices, and/or one or more configurable clock trees.

The processor 1912 is responsible for managing the bus 1916 and general processing, including the execution of software stored on the processor-readable storage medium 1914. The software, when executed by the processor 1912, causes the processing circuit 1902 to perform the various functions described supra for any particular apparatus. The processor-readable storage medium 1914 may be used for storing data that is manipulated by the processor 1912 when executing software.

In one configuration, the processing circuit may include one or more modules and/or circuits 1904 for encoding data words with EDCs in transition numbers, one or more modules and/or circuits 1906 for generating sequences of symbols based on the transition numbers to obtain, one or more modules and/or circuits 1908 for transmitting the sequences of symbols in the signaling state of the multi-wire interface 1920, and one or more modules and/or circuits 1910 configured to insert marker digits in a ternary transition number.

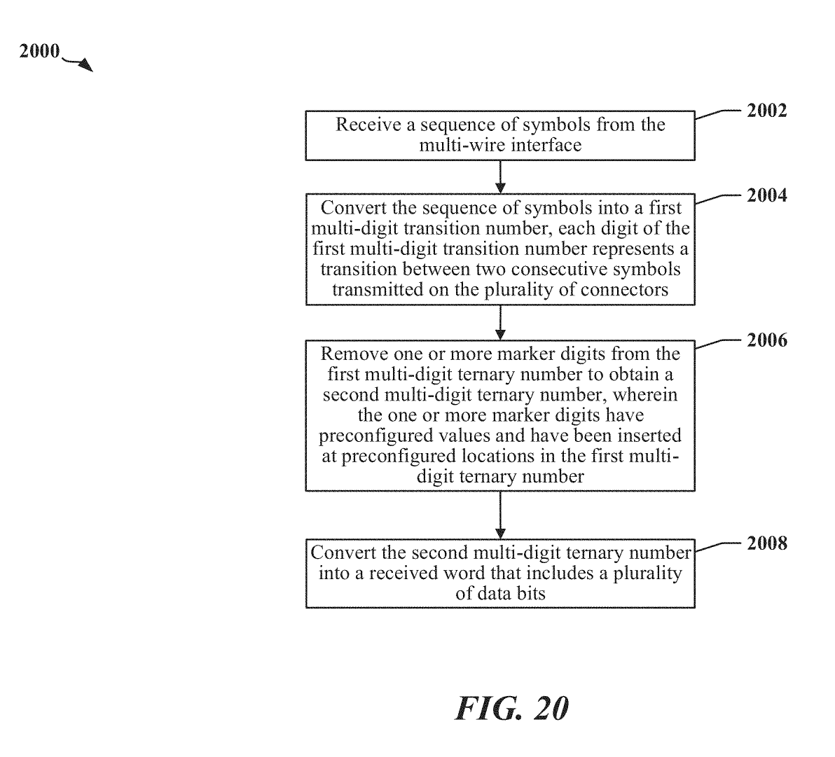

FIG. 20 is a flowchart 2000 illustrating a method for data communications on a multi-wire communications interface that employs transcoding. The method may be performed using a receiving circuit.

At block 2002, the receiving circuit may receive a sequence of symbols from the multi-wire interface.

At block 2004, the receiving circuit may convert the sequence of symbols into a first multi-digit transition number. Each digit of the first multi-digit transition number may represent a transition between two consecutive symbols transmitted on the plurality of connectors.

At block 2006, the receiving circuit may remove one or more marker digits from the first multi-digit ternary number to obtain a second multi-digit ternary number. The one or more marker digits may have preconfigured values. The one or more marker digits may have been inserted at preconfigured locations in the first multi-digit ternary number.

At block 2008, the receiving circuit may convert the second multi-digit ternary number into a received word that includes a plurality of data bits.

In some examples, the receiving circuit may compare the one or more marker digits to one of two valid values. The receiving circuit may determine that a transmission error has affected the sequence of symbols when any of the one or more marker digits do not have one of the two valid values.

The receiving circuit may compare an error detection constant in the received word to a known value for error detection constants. The receiving circuit may determine that a transmission error has affected the sequence of symbols when the error detection constant has a value different from the known value.

In one example, the one or more marker digits may be separated by groups of three digits in the first multi-digit ternary number. In another example, one marker digit is present in the first multi-digit ternary number.

The second multi-digit ternary number may have twelve digits. The received word may be a binary word with twenty bits.

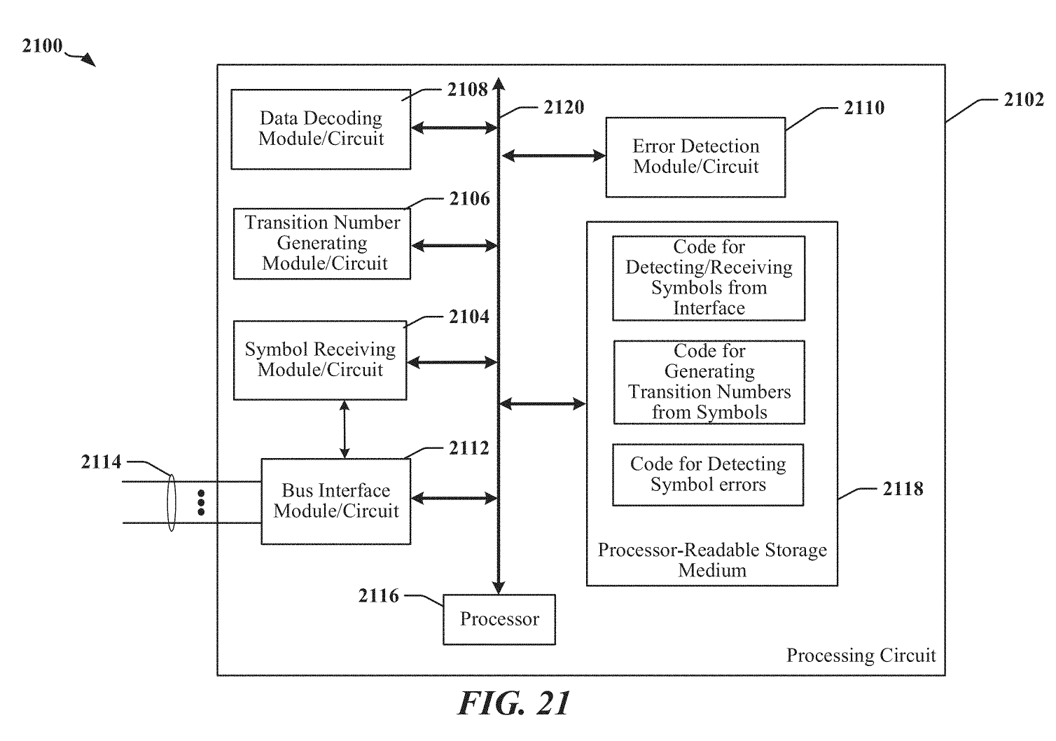

FIG. 21 is a conceptual diagram illustrating an example of a hardware implementation for an apparatus 2100 employing a processing circuit 2102. In this example, the processing circuit 2102 may be implemented with a bus architecture, represented generally by the bus 2116. The bus 2116 may include any number of interconnecting buses and bridges depending on the specific application of the processing circuit 2102 and the overall design constraints. The bus 2116 links together various circuits including one or more processors, represented generally by the processor 2112, and processor-readable media, represented generally by the processor-readable storage medium 2114. The bus 2116 may also link various other circuits such as timing sources, timers, peripherals, voltage regulators, and power management circuits. A transceiver or communications interface 2118 provides a means for communicating with various other apparatus over a multi-wire interface 2120. Depending upon the nature of the apparatus, a user interface (e.g., keypad, display, speaker, microphone, joystick) may also be provided. One or more clock generation circuits may be provided within the processing circuit 2102 or controlled by the processing circuit 2102 and/or one or more processors 2112. In one example, the clock generation circuits may include one or more crystal oscillators, one or more phase-locked loop devices, and/or one or more configurable clock trees.

The processor 2112 is responsible for managing the bus 2116 and general processing, including the execution of software stored on the processor-readable storage medium 2114. The software, when executed by the processor 2112, causes the processing circuit 2102 to perform the various functions described supra for any particular apparatus. The processor-readable storage medium 2114 may be used for storing data that is manipulated by the processor 2112 when executing software.

In one configuration, the processing circuit may include one or more modules and/or circuits 2104 for receiving sequences of symbols from the multi-wire interface 2120, one or more modules and/or circuits 2106 for generating transition numbers from the sequences of symbols, one or more modules and/or circuits 2108 for decoding data words from the transition numbers, and one or more modules and/or circuits 2110 for detecting symbol errors using an EDC decoded from the transition numbers.

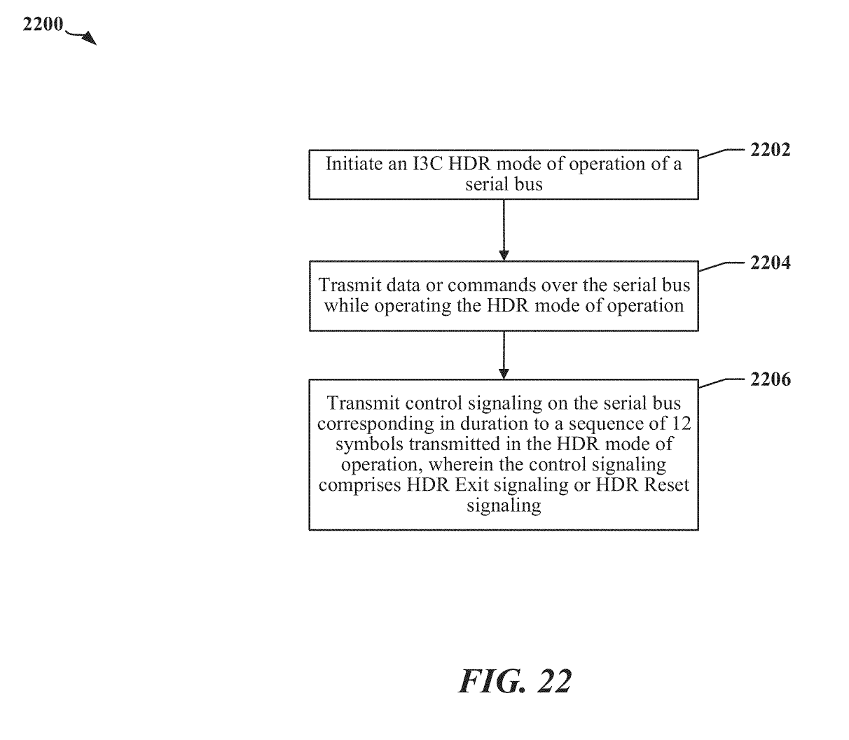

FIG. 22 is a flowchart 2200 illustrating a method for controlling a multi-wire communications interface that employs transcoding. The method may be performed using a bus master device.

At block 2202, the bus master device may initiate an I3C HDR mode of operation of the serial bus.

At block 2204, the bus master device may transmit data or commands over the serial bus while operating the HDR mode of operation.

At block 2206, the bus master device may transmit control signaling on the serial bus corresponding in duration to a sequence of 12 symbols transmitted in the HDR mode of operation. The control signaling may include HDR Exit signaling. The control signaling may include HDR Restart signaling.

Those of skill in the art would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method of transmitting data on a multi-wire interface, comprising:
providing a plurality of data bits in a word to be transmitted on the multi-wire interface;
transcoding the word to be transmitted to obtain a first multi-digit ternary number representative of numerical value of the word to be transmitted;
inserting one or more marker digits into the first multi-digit ternary number to obtain a second multi-digit ternary number, wherein the one or more marker digits have preconfigured values and are inserted at preconfigured locations in the first multi-digit ternary number; and
generating a sequence of symbols, wherein each symbol in the sequence of symbols is generated using a digit of the second multi-digit ternary number and a preceding symbol in the sequence of symbols, wherein clock information is embedded in transitions between consecutive symbols in the sequence of symbols,
wherein each symbol controls signaling state the multi-wire interface during a corresponding symbol transmission interval, and
wherein the preconfigured values and the preconfigured locations of the one or more marker digits are selected to prevent occurrence of I3C HDR Exit or HDR I3C Restart signaling when the sequence of symbols is transmitted on the multi-wire interface.

2. The method of claim 1, wherein the one or more marker digits are inserted between each group of three digits in the first multi-digit ternary number.

3. The method of claim 1, wherein a single marker digit is inserted in the first multi-digit ternary number.

4. The method of claim 1, wherein the marker digit has one of two preconfigured values.

5. The method of claim 1, further comprising:
providing an error detection constant (EDC) in the word to be transmitted.

6. The method of claim 5, wherein a length and a known value of the EDC are selected such that a transmission error affecting the one or more symbols in the sequence of symbols results in the EDC having a value different from the known value when decoded.

7. The method of claim 1, wherein the first multi-digit ternary number has twelve digits.

8. The method of claim 1, wherein the word to be transmitted is a binary word with twenty bits.

9. The method of claim 1, and further comprising:
initiating an I3C High Data Rate (HDR) mode of operation of the multi-wire interface;
transmitting data or commands over the multi-wire interface while operating the HDR mode of operation; and
transmitting control signaling on the multi-wire interface corresponding in duration to a sequence of 12 symbols transmitted in the HDR mode of operation, wherein the control signaling comprises HDR Exit signaling or HDR Restart signaling.

10. An apparatus comprising:
means for coupling the apparatus to a multi-wire interface, wherein the means for coupling the apparatus is configured to support data communication on the multi-wire interface;
means for providing a plurality of data bits in a word to be transmitted on the multi-wire interface;
means for transcoding the word to be transmitted to obtain a first multi-digit ternary number representative of numerical value of the word to be transmitted;
means for inserting one or more marker digits into the first multi-digit ternary number to obtain a second multi-digit ternary number, wherein the one or more marker digits have preconfigured values and are inserted at preconfigured locations in the first multi-digit ternary number; and
means for generating a sequence of symbols, wherein each symbol in the sequence of symbols is generated using a digit of the second multi-digit ternary number and a preceding symbol in the sequence of symbols, wherein clock information is embedded in transitions between consecutive symbols in the sequence of symbols,
wherein each symbol controls signaling state the multi-wire interface during a corresponding symbol transmission interval, and
wherein the preconfigured values and the preconfigured locations of the one or more marker digits are selected to prevent occurrence of I3C HDR Exit or HDR I3C Restart signaling when the sequence of symbols is transmitted on the multi-wire interface.

11. The apparatus of claim 10, wherein the one or more marker digits are inserted between each group of three digits in the first multi-digit ternary number.

12. The apparatus of claim 10, wherein a single marker digit is inserted in the first multi-digit ternary number.

13. The apparatus of claim 12, wherein the single marker digit has one of two preconfigured values.

14. The apparatus of claim 10, further comprising:
means for providing an error detection constant (EDC) in the word to be transmitted, wherein the means for providing the EDC is configured to select a length and a known value of the EDC such that a transmission error affecting the one or more symbols in the sequence of symbols results in the EDC having a value different from the known value when decoded.

15. The apparatus of claim 10, wherein the first multi-digit ternary number has twelve digits.

16. The apparatus of claim 10, wherein the word to be transmitted is a binary word with twenty bits.

17. A method of receiving data from a multi-wire interface, comprising:
receiving a sequence of symbols from the multi-wire interface;
converting the sequence of symbols into a first multi-digit ternary number, each digit of the first multi-digit ternary number represents a transition between two consecutive symbols transmitted on the multi-wire interface;
removing one or more marker digits from the first multi-digit ternary number to obtain a second multi-digit ternary number, wherein the one or more marker digits have preconfigured values and have been inserted at preconfigured locations in the first multi-digit ternary number; and
converting the second multi-digit ternary number into a received word that includes a plurality of data bits.

18. The method of claim 17, further comprising:
comparing the one or more marker digits to one of two valid values; and
determining that a transmission error has affected the sequence of symbols when any of the one or more marker digits do not have one of the two valid values.

19. The method of claim 17, further comprising:
comparing an error detection constant in the received word to a known value for error detection constants; and
determining that a transmission error has affected the sequence of symbols when the error detection constant has a value different from the known value.

20. The method of claim 17, wherein the one or more marker digits are separated by groups of three digits in the first multi-digit ternary number.

21. The method of claim 17, wherein one marker digit is present in the first multi-digit ternary number.

22. The method of claim 17, wherein the second multi-digit ternary number has twelve digits.

23. The method of claim 17, wherein the received word is a binary word with twenty bits.

24. An apparatus comprising:
means for receiving a sequence of symbols from a multi-wire interface;
means for converting the sequence of symbols into a first multi-digit ternary number, each digit of the first multi-digit ternary number represents a transition between two consecutive symbols transmitted on the multi-wire interface;
means for removing one or more marker digits from the first multi-digit ternary number to obtain a second multi-digit ternary number, wherein the one or more marker digits have preconfigured values and have been inserted at preconfigured locations in the first multi-digit ternary number; and
means for converting the second multi-digit ternary number into a received word that includes a plurality of data bits.

25. The apparatus of claim 24, wherein the means for removing the one or more marker digits is configured to:
comparing the one or more marker digits to one of two valid values; and
determining that a transmission error has affected the sequence of symbols when any of the one or more marker digits do not have one of the two valid values.

26. The apparatus of claim 24, further comprising:
means for detecting a transmission error configured to:
compare an error detection constant in the received word to a known value for error detection constants; and
determine that a transmission error has affected the sequence of symbols when the error detection constant has a value different from the known value.

27. The apparatus of claim 24, wherein the one or more marker digits are separated by groups of three digits in the first multi-digit ternary number.

28. The apparatus of claim 24, wherein one marker digit is present in the first multi-digit ternary number.

29. The apparatus of claim 24, wherein the second multi-digit ternary number has twelve digits.

30. The apparatus of claim 24, wherein the received word is a binary word with twenty bits.
